(19) United States
(12) Patent Application Publication
(10) Pub. No.: US 2026/0172734 A1
(43) Pub. Date: Jun. 18, 2026

(54) HEADPHONE

(71) Applicant: Beijing Zitiao Network Technology Co., Ltd., Beijing (CN)

(72) Inventors: Yu YU, Beijing (CN); Jianhui HUANG, Beijing (CN); Chuanbo WANG, Beijing (CN); Shudong LIU, Beijing (CN)

(21) Appl. No.: 19/393,380

(22) Filed: Nov. 18, 2025

(30) Foreign Application Priority Data
Dec. 13, 2024 (CN) 202423096059.3
Feb. 27, 2025 (CN) 202510231403.5
Feb. 27, 2025 (CN) 202520337830.7

(51) Int. Cl. H04R 1/10

(52) U.S. Cl. CPC H04R 1/1041; H04R 1/1016; H04R 1/105

(57) ABSTRACT

The disclosure provides a headphone. The headphone includes: a sound generating part, configured to be worn on a front side of an ear, and including a speaker unit; a main body part, configured to be worn on a rear side of the ear; an ear clip part, opposite ends of which being respectively connected to the sound generating part and the main body part, and the ear clip part being configured to switch between a first form and a second form; a form detecting apparatus, provided on at least one of the sound generating part and the main body part, and configured to detect a wearing form of the ear clip part; and a control apparatus, configured to control an audio output state of the speaker unit according to a detection result of the form detecting apparatus.

### CROSS-REFERENCE TO RELATED APPLICATIONS

This application claims the priority to and benefits of Chinese Patent Application No. 202510231403.5, which was filed on February 27, 2025, Chinese Patent Application No. 202520337830.7, which was filed on February 27, 2025, and Chinese Patent Application No. 202423096059.3, which was filed on December 13, 2024. The aforementioned patent applications are hereby incorporated by reference in its entirety.

### TECHNICAL FIELD

The disclosure relates to the technical field of headphones, and in particular, to a headphone.

### BACKGROUND

Common headphones include in-ear headphones and open-back headphones. The headphones generally have a wearing detection function, which is mainly used for detecting whether the headphones are worn. When it is detected that the headphones are not worn, the audio output is automatically turned off to reduce power consumption. When it is detected that the headphones are in a wearing state, functions such as the audio output of the headphones are restored to normal.

However, the existing headphones are single in form, and there are no multiple usage modes. For example, the open-back headphones have only an open mode, and the in-ear headphones have only an immersive mode. There are no headphones with multiple wearing modes, and there is no switching detection between the multiple wearing modes and implementation of different audio outputs in the different wearing modes. It is difficult to meet the requirement of the user for automatic switching of multiple usage scenarios.

Moreover, whether it is a clip-on headphone or an ear-hook headphone, both need to be clipped or hooked onto the ears to reduce the risk of the headphones falling off when the user is exercising or moving. However, the existing headphones have a relatively single usage posture and acoustic effects, and cannot take into account both comfort and sound quality.

### SUMMARY

At least one embodiment of the disclosure provides a headphone, including: a sound generating part, configured to be worn on a front side of an ear, and the sound generating part including a speaker unit; a main body part, configured to be worn on a rear side of the ear; an ear clip part, opposite ends of the ear clip part being respectively connected to the sound generating part and the main body part, and the ear clip part being configured to switch between a first form and a second form, where in the first form, the sound generating part and the main body part jointly clamp the ear, and in the second form, the sound generating part extends into a concha cavity and abuts against a tragus; a form detecting apparatus, provided on at least one of the sound generating part and the main body part, and the form detecting apparatus being configured to detect a wearing form of the ear clip part; and a control apparatus, provided on the sound generating part and electrically connected to the form detecting apparatus, and the control apparatus being configured to control an audio output state of the speaker unit according to a detection result of the form detecting apparatus.

In at least one embodiment, the ear clip part includes an anterior ear section located on the front side of the ear and a posterior ear section located on the rear side of the ear, and the anterior ear section is adapted to deform under an external force to enable the ear clip part to switch between the first form and the second form.

In at least one embodiment, in a case that the ear clip part is in the first form, the anterior ear section is convex in a direction away from the ear, and in a case that the ear clip part is in the second form, the anterior ear section is concave in a direction close to the ear, to enable the sound generating part to move in a direction close to the tragus and an ear canal.

In at least one embodiment, the sound generating part includes a first housing, the main body part includes a second housing, and the form detecting apparatus includes a magnetic member and a hall sensor, one of the magnetic member and the hall sensor being provided in an inner cavity of the first housing, and the other being provided in an inner cavity of the second housing, the hall sensor being configured to detect a magnetic induction intensity of the magnetic member, and the hall sensor being connected to the control apparatus, and the control apparatus being configured to determine the wearing form of the headphone according to a signal change of the magnetic induction intensity detected by the hall sensor.

In at least one embodiment, the magnetic member is provided in the inner cavity of the first housing, and the hall sensor is provided in the inner cavity of the second housing.

In at least one embodiment, the form detecting apparatus further includes: a magnetic conductive cover, the magnetic conductive cover being arranged on an outer side of the magnetic member.

In at least one embodiment, the control apparatus is provided in the inner cavity of the first housing; and the magnetic member and the speaker unit are respectively arranged on opposite sides of the control apparatus in a direction of a human coronal axis.

In at least one embodiment, a projection of the magnetic member on a human sagittal plane and a projection of the speaker unit on the human sagittal plane are at least partially staggered.

In at least one embodiment, the sound generating part includes a first housing, the first housing is provided with a light-transmitting window, in the first form, an opening direction of the light-transmitting window is away from a human body, and in the second form, the light-transmitting window is at least partially blocked by the human body, the form detecting apparatus further includes an infrared sensor provided in the first housing and adapted to emit and receive infrared rays through the light-transmitting window, and the infrared sensor being electrically connected to the control apparatus, and the control apparatus being configured to determine the wearing form of the headphone according to a signal change of reflected infrared rays received by the infrared sensor.

In at least one embodiment, in the second form, the light-transmitting window is opposite to the tragus.

In at least one embodiment, the infrared sensor includes an infrared transmitting unit and an infrared receiving unit, the infrared transmitting unit is configured to emit infrared rays outward from the light-transmitting window, the infrared receiving unit is configured to receive infrared rays reflected back by the human body from the light-transmitting window, and the infrared receiving unit is electrically connected to the control apparatus, and the control apparatus is configured to determine the wearing form of the headphone according to a signal change of the reflected infrared rays received by the infrared receiving unit.

In at least one embodiment, the first housing includes an inner sidewall facing a human body and an outer sidewall away from the human body in a direction of a human coronal axis, the light-transmitting window is provided on the outer sidewall, and the light-transmitting window is located at a front portion of the outer sidewall in a direction of a human sagittal axis.

In at least one embodiment, the form detecting apparatus includes a capacitive sensor separated from an ear in the first form and in contact with the ear in the second form; and the capacitive sensor being electrically connected to the control apparatus, and the control apparatus being configured to determine the wearing form of the headphone according to a signal change generated by the capacitive sensor.

In at least one embodiment, in the second form, the capacitive sensor is in contact with the tragus.

In at least one embodiment, the sound generating part includes a first housing, the first housing is provided with a mounting window, and the capacitive sensor is fixed in the mounting window.

In at least one embodiment, an outer surface of the capacitive sensor is flush with an outer surface of the first housing, or the outer surface of the capacitive sensor protrudes from the outer surface of the first housing.

In at least one embodiment, the first housing includes an inner sidewall facing a human body and an outer sidewall away from the human body in a direction of a human coronal axis, the mounting window is provided on the outer sidewall, and the mounting window is located at a front portion of the outer sidewall in a direction of a human sagittal axis.

At least one embodiment of the disclosure provides a headphone system, including: a headphone case having a storage compartment; and the above-mentioned headphone, the headphone being removably arranged in the storage compartment.

At least one embodiment of the disclosure provides a headphone control method, which is applicable to the above-mentioned headphone, where the headphone control method includes the following steps:

determining a wearing form of the headphone, the wearing form including a first form and a second form; and

controlling an audio output state of the speaker unit according to the wearing form.

In at least one embodiment, the determining the wearing form of the headphone, includes at least one: determining the wearing form of the headphone according to a signal change of a magnetic induction intensity detected by a hall sensor; determining the wearing form of the headphone according to a signal change of reflected infrared rays received by an infrared sensor; or determining the wearing form of the headphone according to a signal change generated by a capacitive sensor.

At least one embodiment of the disclosure provides a headphone, including: a sound generating part, configured to be worn on a front side of an ear, and the sound generating part including a speaker unit; a main body part, configured to be worn on a rear side of the ear; an ear clip part, opposite ends of the ear clip part being respectively connected to the sound generating part and the main body part, and the ear clip part being configured to switch between a first form and a second form, where in the first form, the sound generating part and the main body part jointly clamp the ear, and in the second form, the sound generating part extends into a concha cavity and abuts against a tragus; a form detecting apparatus, provided on the ear clip part, and the form detecting apparatus being configured to detect the form of the ear clip part; and a control apparatus, provided on the sound generating part and electrically connected to the form detecting apparatus, and the control apparatus being configured to control an audio output state of the speaker unit according to a detection result of the form detecting apparatus.

In at least one embodiment, the ear clip part includes an anterior ear section located on the front side of the ear and a posterior ear section located on the rear side of the ear, and the anterior ear section is adapted to deform under an external force to enable the ear clip part to switch between the first form and the second form.

In at least one embodiment, in a case that the ear clip part is in the first form, the anterior ear section is convex in a direction away from the ear, and in a case that the ear clip part is in the second form, the anterior ear section is concave in a direction close to the ear, to enable the sound generating part to move in a direction close to the tragus and an ear canal.

In at least one embodiment, the ear clip part includes: a wrapping piece; and a deformation assembly, disposed in an inner cavity of the wrapping piece and located in the anterior ear section, and the deformation assembly including: a main deformable body and a deformable driving body, both the main deformable body and the deformable driving body being curved, and the deformable driving body having a different curvature radius from that of the main deformable body, the deformable driving body being arranged in a stacked manner with the main deformable body and located on a side of the main deformable body away from the ear, a first end of the main deformable body being fixedly connected to a first end of the deformable driving body, and a second end of the main deformable body being slidably connected to a second end of the deformable driving body, and the deformable driving body being adapted to slide relative to the main deformable body and drive the main deformable body to deform under an external force.

In at least one embodiment, the form detecting apparatus includes a stress sensor disposed on the anterior ear section and configured to sense a stress change of the anterior ear section in a case that the anterior ear section deforms.

In at least one embodiment, the stress sensor is disposed in a middle portion of the anterior ear section.

In at least one embodiment, the ear clip part includes a wrapping piece, and the stress sensor is wrapped inside the wrapping piece.

In at least one embodiment, the stress sensor includes a strain gauge.

In at least one embodiment, the form detecting apparatus includes an electronic switch including a first switch part and a second switch part, and the first switch part is movable relative to the second switch par. In the first form, the first switch part is separated from the deformable driving body, and the first switch part and the second switch part are disconnected. In the second form, the deformable driving body drives the first switch part to move so that the first switch part and the second switch part forms a closed circuit.

In at least one embodiment, the first switch part is disposed on a sliding path at the second end of the deformable driving body, and the second end of the deformable driving body is an end of the deformable driving body close to the sound generating part.

In at least one embodiment, the electronic switch and the deformation assembly are arranged along a vertical axis direction of a human body.

In at least one embodiment, the electronic switch is wrapped inside the wrapping piece.

At least one embodiment of the disclosure provides a headphone system including any of above headphones.

An embodiment of the present disclosure provides a headphone including a main body and a locking piece. The main body includes at least a first main body part and a first deformation part that are connected to each other, the first deformation part being adapted to be connected to a sound generating part of the headphone, the first deformation part including a first wearing state and a second wearing state, and a distance between the sound generating part and an ear canal orifice in the first wearing state being greater than that in the second wearing state. One end of the locking piece is movably connected to the first main body part, and the other end of the locking piece is selectively connected to the first deformation part, so that the first deformation part and the locking piece switch between a locked state and an unlocked state. When the first deformation part and the locking piece are in the locked state, the first deformation part is in the first wearing state. When the first deformation part and the locking piece are in the unlocked state, the first deformation part is in the second wearing state.

In at least one embodiment, when the locking piece moves in a direction away from the first deformation part, the locking piece is separated from at least a portion of the first deformation part so that the first deformation part and the locking piece are in the unlocked state. When the locking piece moves in a direction toward the first deformation part, the locking piece is connected to the first deformation part so that the first deformation part and the locking piece are in the locked state.

In at least one embodiment, one end of the locking piece is slidably disposed on the first main body part, or one end of the locking piece is rotatably connected to the first main body part.

In at least one embodiment, one of the locking piece and the first main body part is provided with a sliding protrusion, and the other of the locking piece and the first main body part is provided with a sliding groove. The sliding protrusion is slidably disposed in the sliding groove.

In at least one embodiment, when the first deformation part and the locking piece are in the locked state, the locking piece is located on the first main body part and is disposed in contact with the first deformation part.

In at least one embodiment, the headphone further includes a second main body part disposed on a side of the first deformation part away from the first main body part. The other end of the locking piece is selectively connectable to the second main body part.

In at least one embodiment, when the first deformation part and the locking piece are in the locked state, the locking piece is disposed in contact with the first deformation part and at least a portion of the second main body part.

In at least one embodiment, one of the locking piece and the first main body part is provided with a locking groove, and the other of the locking piece and the first main body part is provided with an elastic protrusion. When the elastic protrusion is engaged with the locking groove, the first deformation part and the locking piece are in the locked state.

In at least one embodiment, the headphone includes a flexible housing, the first main body part and the second main body part are disposed in the flexible housing at a distance from each other, and a region of the flexible housing between the first main body part and the second main body part constitutes the first deformation part.

### BRIEF DESCRIPTION OF DRAWINGS

The drawings herein, which are incorporated in this description and constitute a part thereof, illustrate embodiments consistent with the disclosure and, together with the description, serve to explain the principles of the disclosure.

FIG. 1 is a schematic diagram of an ear according to an embodiment of the present disclosure;

FIG. 2 is a structural schematic diagram of a headphone with an ear clip part in a first form according to at least one embodiment of the disclosure;

FIG. 3 is a structural schematic diagram of a headphone with an ear clip part in a second form according to at least one embodiment of the disclosure;

FIG. 4 is a structural schematic diagram of a deformation assembly of a headphone according to at least one embodiment of the disclosure;

FIG. 5 is a structural schematic diagram of a deformation assembly in a first form according to at least one embodiment of the disclosure;

FIG. 6 is a structural schematic diagram of a deformation assembly in a second form according to at least one embodiment of the disclosure;

FIG. 7 is a use state diagram of a deformation assembly in a first form according to at least one embodiment of the disclosure;

FIG. 8 is a use state diagram of a deformation assembly in a second form according to at least one embodiment of the disclosure;

FIG. 9 is a use state diagram of a headphone using a magnetic member and a hall sensor in a first form according to at least one embodiment of the disclosure;

FIG. 10 is a use state diagram of a headphone using a magnetic member and a hall sensor in a second form according to at least one embodiment of the disclosure;

FIG. 11 is a use state diagram of a headphone using an infrared sensor in a first form according to at least one embodiment of the disclosure;

FIG. 12 is a use state diagram of a headphone using an infrared sensor in a second form according to at least one embodiment of the disclosure;

FIG. 13 is a use state diagram of a headphone using a capacitive sensor in a first form according to at least one embodiment of the disclosure;

FIG. 14 is a use state diagram of a headphone using a capacitive sensor in a second form according to at least one embodiment of the disclosure; and

FIG. 15 is a schematic diagram of control logic of a headphone control method according to at least one embodiment of the disclosure.

FIG. 16 is a structural schematic diagram of a headphone with an ear clip part in a first form according to at least one embodiment of the disclosure;

FIG. 17 is a structural schematic diagram of a headphone with an ear clip part in a first form according to at least one embodiment of the disclosure;

FIG. 18 is a structural schematic diagram of a headphone with an ear clip part in a second form according to at least one embodiment of the disclosure;

FIG. 19 is a structural schematic diagram of a headphone with an ear clip part in a second form according to at least one embodiment of the disclosure;

FIG. 20 is a structural schematic diagram of a headphone with an ear clip part in a first form according to at least one embodiment of the disclosure;

FIG. 21 is a structural schematic diagram of a headphone with an ear clip part in a second form according to at least one embodiment of the disclosure;

FIG. 22 is a schematic wearing view of the headphone in the first form according to at least one embodiment of the disclosure;

FIG. 23 is a schematic wearing view of the headphone in the second form according to at least one embodiment of the disclosure;

FIG. 24 is a schematic diagram of a headphone in a first wearing state according to at least one embodiment of the disclosure;

FIG. 25 is a schematic diagram of a headphone in an unlocked state according to at least one embodiment of the disclosure;

FIG. 26 is a schematic diagram of a headphone in a second wearing state according to at least one embodiment of the disclosure;

FIG. 27 is an internal schematic diagram of a headphone in a first wearing state according to at least one embodiment of the disclosure;

FIG. 28 is an internal schematic diagram of a headphone in an unlocked state according to at least one embodiment of the disclosure;

FIG. 29 is an internal schematic diagram of a headphone in a second wearing state according to at least one embodiment of the disclosure;

FIG. 30 is a schematic diagram of a headphone worn on an ear in a first wearing state according to at least one embodiment of the disclosure; and

FIG. 31 is a schematic diagram of a headphone worn on an ear in a second wearing state according to at least one embodiment of the disclosure.

### List of reference numerals:

200: ear; 211: helix; 212: concha; 202: cavum conchae; 222: cymba conchae; 201: tragus; 214: antitragus; 15: antihelix; 151: superior crus of antihelix; 152: inferior crus of antihelix; 16: triangular fossa; 17: crus of helix; 18: ear canal orifice; 19: earlobe; 100, 1000, 1100: headphone; 110, 1110: sound generating part; 111: first housing; 112: light-transmitting window; 113: mounting window; 114: inner sidewall; 115: outer sidewall; 120, 1120: main body part; 121: second housing; 130, 1130: ear clip part; 131, 1131: anterior ear section; 132, 1132: posterior ear section; 133, 1133: wrapping piece; 134, 1134: deformation assembly; 1341: first deformation piece; 1342: second deformation piece; 1343: limiting post; 1343a: post body; 1343b: limiting head; 1344: limiting slot; 1344a: first limiting section; 1344b: second limiting section; 1344c: transition connecting section; 1341-1: main deformable body; 1342-2: deformable driving body; 1135: sliding groove; 1136: fixing piece; 140, 1140: form detecting apparatus; 141: magnetic member; 142: hall sensor; 143: infrared sensor; 144: capacitive sensor; 1141: stress sensor; 1142: electronic switch; 1421-1: first switch part; 1422-1: second switch part; 1001: main body; 1101: first main body part; 1201: first deformation part; 1301: second main body part; 1401: second deformation part; 1501: locking groove; 1601: elastic protrusion; 2001: locking piece; 3001: sound generating part; and 4001: balancing part;

Through the above drawings, explicit embodiments of the present disclosure have been shown, which will be described in more detail hereinafter. These drawings and text descriptions are not intended to limit the scope of the concept of the present application in any way, but to illustrate the concept of the present application for those skilled in the art by referring to specific embodiments

### DETAILED DESCRIPTION

Reference will now be made in detail to the exemplary embodiments, examples of which are illustrated in the drawings. When referring to the drawings, the same reference numerals in different drawings refer to the same or similar elements, unless otherwise specified. The implementations described in the following exemplary embodiments do not represent all implementations consistent with the present application. Rather, they are merely examples of apparatuses and methods consistent with some aspects of the present application as detailed in the appended claims.

Common headphones include in-ear headphones and open-back headphones. The headphones generally have a wearing detection function, which is mainly used for detecting whether the headphones are worn. When it is detected that the headphones are not worn, the audio output is automatically turned off to reduce power consumption. When it is detected that the headphones are in a wearing state, functions such as the audio output of the headphones are restored to normal. However, the existing headphones are single in form, and there are no multiple usage modes. For example, the open-back headphones have only an open mode, and the in-ear headphones have only an immersive mode. There are no headphones with multiple wearing modes, and there is no switching detection between the multiple wearing modes and implementation of different audio outputs in the different wearing modes. It is difficult to meet the requirement of the user for automatic switching of multiple usage scenarios.

The present disclosure provides a headphone, a headphone system, and a headphone control method. A form detecting apparatus is provided on at least one of a sound generating part and a main body part, a wearing form of an ear clip part is detected by the form detecting apparatus, and then a control apparatus controls an audio output of a speaker unit according to a detection result of the form detecting apparatus, which may ensure that after the headphone switches a wearing mode, the headphone may output audio matching the wearing mode, so as to satisfy the user’s sound quality requirements for the headphone in terms of volume, sound effect, noise prevention, etc. in different wearing modes, which is favorable for improving the user experience.

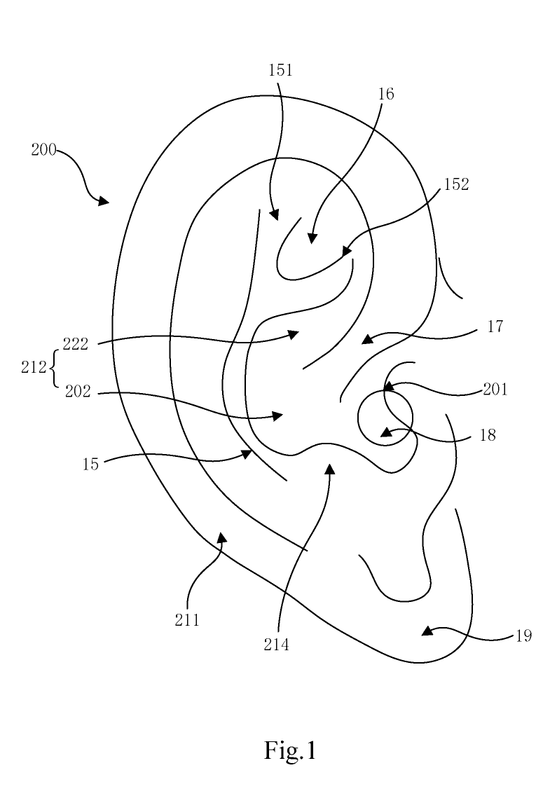

Referring to FIG. 1, the user's ear 200 includes structures such as a helix 211, a concha 212, a tragus 201, an antitragus 214, an antihelix 15, a superior crus of antihelix 151, an inferior crus of antihelix 152, a triangular fossa 16, a crus of helix 17, an ear canal orifice 18, an earlobe 19 and so on. The concha 212 may include a cymba conchae 222 and a cavum conchae 202.

In order to clearly describe the structure of the headphone according to the disclosure, the following will describe the structure of the ear and the wearing state, the front side, the rear side, the upper side and the lower side of the ear, the human sagittal plane, the coronal plane, the horizontal plane, the sagittal axis, the coronal axis and the vertical axis involved in the text.

The front side and the rear side of the ear are defined as follows. The "front side of the ear" described in the disclosure is a concept relative to the "rear side of the ear", the former refers to a side of the ear away from the head, the latter refers to a side of the ear toward the head. An "upper edge of the ear" refers to an outer edge of an upper side of the helix of the ear, and a "lower edge of the ear" refers to an outer edge of a lower side of the helix of the ear, which are all for the user's ear.

The human sagittal plane, the coronal plane, the horizontal plane, the sagittal axis, the coronal axis and the vertical axis are defined as follows. As is well known, in the fields of medicine and anatomy, three basic sections of the human body, namely a sagittal plane, a coronal plane and a horizontal plane, and three basic axes of the human body, namely a sagittal axis, a coronal axis and a vertical axis, may be defined. The sagittal plane refers to a section perpendicular to the ground along a front-back direction of the body, which divides the human body into left and right parts; the coronal plane refers to a section perpendicular to the ground along a left-right direction of the body, which divides the human body into front and rear parts; and the horizontal plane refers to a section parallel to the ground along an up-down direction of the body, which divides the human body into upper and lower parts. Correspondingly, the sagittal axis refers to an axis that passes through the coronal plane vertically along the front-back direction of the body, the coronal axis refers to an axis that passes through the sagittal plane vertically along the left-right direction of the body, and the vertical axis refers to an axis that passes through the horizontal plane vertically along the up-down direction of the body.

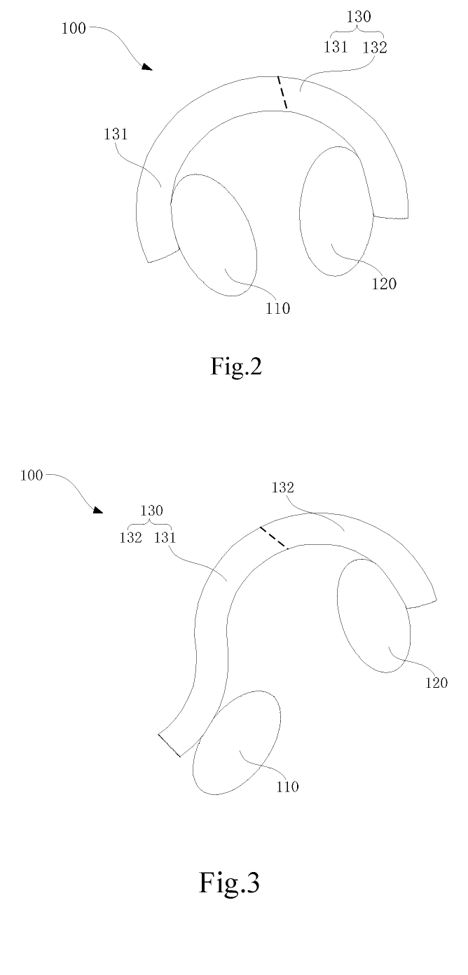

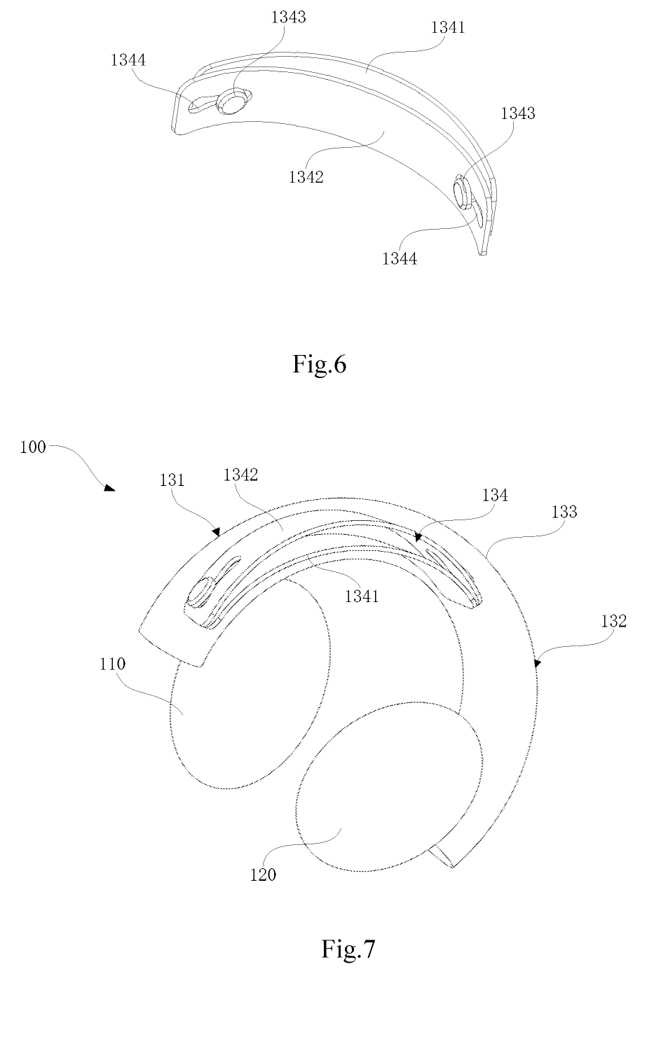

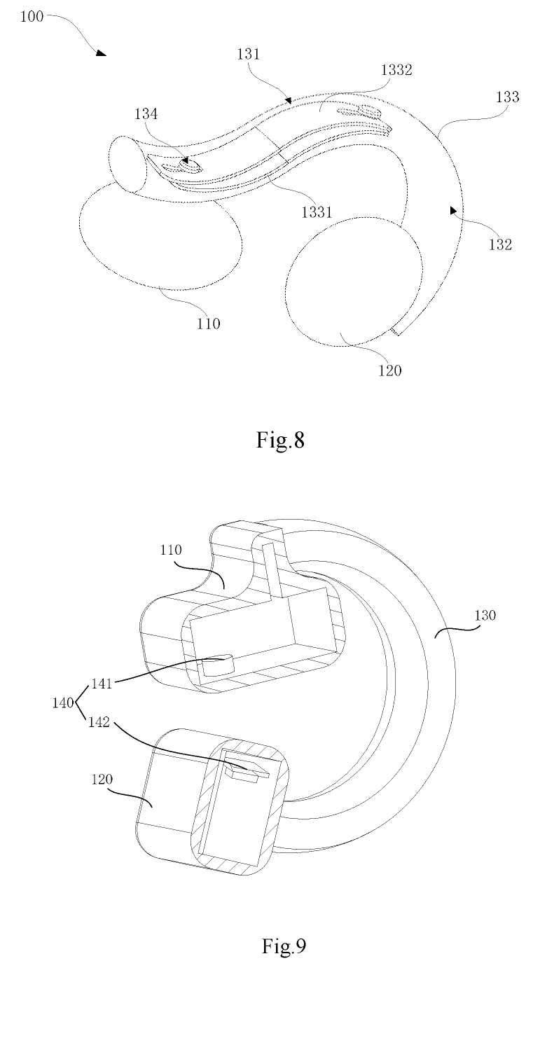

A headphone 100 according to at least one embodiment of the disclosure will be described below with reference to FIG. 2 to FIG. 14.

With reference to FIG. 2, FIG. 3, and FIG. 9 to FIG. 14, the headphone 100 of this embodiment may include a sound generating part 110, a main body part 120, an ear clip part 130, a form detecting apparatus 140, and a control apparatus.

The sound generating part 110 is used for generating sound, and in the wearing state, the sound generating part 110 is located at the front side of the ear. The sound generating part 110 may include at least a speaker unit and a microphone unit. The speaker unit is mainly used for converting an electrical signal into a sound signal, so as to facilitate the wearer of the headphone 100 to receive sound; and the microphone unit may be used for capturing the sound emitted by the wearer of the headphone 100 and converting the sound signal into an electrical signal, so as to facilitate the transmission to other devices.

It may be understood that, in order to facilitate the sound output, the housing of the sound generating part 110 may be provided with at least one sound outlet hole (not shown), and the sound outlet hole is acoustically coupled to the speaker unit. In this way, when the sound generating part 110 is located at the front side of the ear, the sound may be propagated to the ear hole of the ear through the sound outlet hole, so that the user may hear the corresponding sound information.

In some cases, depending on the volume of the housing of the sound generating part 110, an electronic control unit may also be provided in the sound generating part 110. The electronic control unit may include a circuit board, a processor, a communication module, etc. Exemplarily, the circuit board may be a flexible printed circuit (FPC), a printed circuit board (PCB), etc., and the communication module may be a Bluetooth module, a Wifi module, a cellular module, etc. The electronic control unit is respectively connected to the speaker unit and the microphone unit, and the electronic control unit may be used to implement circuit control, control the working state of the speaker, for example, adjust the volume, control the start and stop of the speaker, control the working state of the microphone unit, and may also communicate with the outside.

Correspondingly, in the wearing state, the main body part 120 is located at the rear side of the ear, and the main body part 120 may be at least used to house a battery. Certainly, the above-mentioned electronic control unit may also be arranged in the ear clip part 130, which is not limited in the embodiment of the disclosure.

Opposite ends of the ear clip part 130 are respectively connected to the sound generating part 110 and the main body part 120, and a wire electrically connecting the elements in the main body part 120 and the elements in the sound generating part 110 may be arranged in the ear clip part 130. A flexible circuit board may also be arranged in the ear clip part 130 to control the operation modes of the speaker and the microphone, which may change with the change of the shape of the ear clip part 130.

Further, referring to FIG. 2, FIG. 3, and FIG. 9 to FIG. 14, the ear clip part 130 is configured to be switchable between a first form and a second form. In the first form, the sound generating part 110 and the main body part 120 jointly clamp the ear. At this time, the ear-clip headphone 100 is mainly fixed on the ear by the sound generating part 110 and the main body part 120 clamping the auricle. In this form, the sound generating part 110 is far away from the ear canal, and the ear canal is less pressed, so the damage to the ear canal is small, and the ear-clip headphone 100 may be used as an open-back headphone 100, as shown in FIG. 2. In addition, because the sound generating part 110 is far away from the ear canal at this time, the sound of the external environment may be directly transmitted into the ear canal. Therefore, when the ear clip part 130 is in the first form, it is more suitable for a quiet environment, and the external sound may be heard without affecting the hearing experience of the user, which is favorable for maintaining vigilant against the external environment or making a timely response to emergencies.

In the second form, the sound generating part 110 abuts against the tragus 201. At this time, the ear-clip headphone 100 is fixed on the ear mainly through the sound generating part 110, and the ear clip part 130 and the main body part 120 are only in contact with the auricle, playing an auxiliary limiting role. Therefore, the pressure of the ear-clip headphone 100 on the auricle in the second form is relatively small. Meanwhile, in the second form, the sound generating part 110 is closer to the ear canal, and the sound played by the speaker of the sound generating part 110 may be transmitted to the ear canal faster, reducing the loss of the sound during the propagation process and improving the sound quality, thereby improving the user experience. Meanwhile, because the sound generating part 110 abuts against the tragus 201, the external sound may be better isolated, so it may be applied to a noisy environment to ensure that the user may clearly hear the sound played by the sound generating part 110. At this time, the ear-clip headphone 100 may be used as an in-ear headphone 100.

In at least one embodiment of the disclosure, the form of the ear clip part 130 may be adjusted according to the external environment or the user’s requirements for acoustic effects. When the user is in a quiet environment, or needs to hear the sound of the external environment while listening to the sound played by the headphone 100, the ear clip part 130 may be adjusted to the first form, and when the user needs higher sound quality or is in a noisy environment, the ear clip part 130 may be adjusted to the second form.

In addition, the wearing mode of the ear-clip headphone 100 may also be adjusted for comfort. When the ear clip part 130 is in the first form, the sound generating part 110 and the main body part 120 clamping the auricle of the user for a long time may cause auricle pain to the user. At this time, the ear clip part 130 may also be adjusted to the second form to relieve the pressure on the auricle. When used as an in-ear headphone 100 in the second form, the sound generating part 110 pressing the ear canal orifice for a long time may cause discomfort to the user's ear canal. At this time, the ear clip part 130 may be adjusted to the first form to keep the sound generating part 110 away from the ear canal orifice. Therefore, by adjusting the ear clip part 130 to alternate between the first form and the second form, the problem of local discomfort of the ear caused by the long-term use of a single wearing mode of the ear-clip headphone 100 may be relieved, and the comfort of the user wearing the ear-clip headphone 100 may be improved by enriching the wearing modes of the ear-clip headphone 100.

Therefore, the ear-clip headphone 100 according to the embodiment of the disclosure has various forms, and may adapt to different environments and user needs by adjusting the form of the ear clip part 130, which may not only ensure the wearing comfort of the ear-clip headphone 100, but also achieve different acoustic effects, so as to play high-quality audio according to the user's needs, which is favorable for improving the user experience and satisfying the different needs of the user, thereby expanding the application scenarios of the ear-clip headphone 100.

Referring to FIG. 9 to FIG. 14, the form detecting apparatus 140 is used for detecting the wearing form of the ear clip part 130. The form detecting apparatus 140 may be arranged on at least one of the sound generating part 110 and the main body part 120. For example, the form detecting apparatus 140 may be arranged on the sound generating part 110. In this case, the form detecting apparatus 140 may detect the wearing form of the ear clip part 130 according to the relative position and the fitting contact mode between the sound generating part 110 and the ear in the first form and the second form. Alternatively, the form detecting apparatus 140 may be arranged on the main body part 120. In this case, the form detecting apparatus 140 may detect the wearing form of the ear clip part 130 according to the relative position and the fitting contact mode between the main body part 120 and the ear in the first form and the second form. Still alternatively, the form detecting apparatus 140 is divided into two parts, one part is arranged on the sound generating part 110, and the other part is arranged on the main body part 120. In this case, the wearing form of the ear clip part 130 may be detected by the relative position and the wearing fit mode of the two parts in the first form and the second form.

The control apparatus may be arranged on the sound generating part 110, and the control apparatus may be electrically connected to the form detecting apparatus 140. The control apparatus is configured to control the audio output state of the speaker unit according to the detection result of the form detecting apparatus 140. For example, when it is determined that the wearing form of the headphone 100 is the first form, the headphone 100 is used as an open-back headphone 100, and the control apparatus may regulate the audio output of the speaker unit to appropriately improve the bass effect of the headphone 100. When it is determined that the wearing form of the headphone 100 is the second form, the headphone 100 is used as an in-ear headphone 100, and the control apparatus may regulate the audio output of the speaker unit to enhance the noise reduction effect of the headphone 100.

It may be understood that the control apparatus may be configured to receive the signal fed back by the form detecting apparatus 140, process the signal, and determine the wearing form of the headphone 100. In addition, the control apparatus may also be configured to generate an audio adjustment instruction, send the audio adjustment instruction to the speaker unit, and control the speaker unit to execute the instruction. Optionally, the control apparatus may include a processor, and the processor may implement the above-mentioned functions of the control apparatus. The processor may be a central processing unit (abbreviated as CPU), and may also be other general-purpose processor, a digital signal processor (abbreviated as DSP), an application specific integrated circuit (abbreviated as ASIC), etc. The general-purpose processor may be a microprocessor or any conventional processor, etc.

In the embodiment of the disclosure, the form detecting apparatus 140 is provided on at least one of the sound generating part 110 and the main body part 120. By detecting the wearing form of the ear clip part 130 via the form detecting apparatus 140, and then controlling the audio output of the speaker unit via the control apparatus according to the detection result of the form detecting apparatus 140, it may ensure that after the headphone 100 switches the wearing mode, the headphone 100 can output audio matching the wearing mode, so as to satisfy the user’s sound quality requirements for the headphone 100 in terms of volume, sound effect, noise prevention, etc. in different wearing modes, which is favorable for improving the user experience.

In some implementable manners, with reference to FIG. 2, FIG. 3, and FIG. 9 to FIG. 14, the ear clip part 130 of the embodiment of the disclosure includes an anterior ear section 131 located at the front side of the ear and a posterior ear section 132 located at the rear side of the ear. The anterior ear section 131 is adapted to deform under an external force to enable the sound generating part 110 to switch between the first form and the second form.

In a specific implementation, in order to ensure that the main body part 120 fits the rear side of the ear in both the first form and the second form, thereby maintaining the stability of the ear-clip headphone 100, the posterior ear section 132 needs to be configured to maintain its shape unchanged in the first form and the second form, and the position of the sound generating part 110 on the front side of the ear may be adjusted only by changing the shape of the anterior ear section 131. The anterior ear section 131 is configured to be deformable directly under an external force, so that when the user actually uses the ear-clip headphone 100, the switching of the ear clip part 130 between the first form and the second form may be completed only by pressing the anterior ear section 131. This operation is convenient, helps the user to adjust at any time, and improves the flexibility of the ear-clip headphone 100.

In addition, when the circuit board or other elements in the ear-clip headphone 100 need to be arranged in the ear clip part 130, they may be arranged in the posterior ear section 132, and the shape of the posterior ear section 132 is basically kept unchanged, which may prevent the circuit board from being damaged by the deformation of the anterior ear section 131. The specific layout of the circuit board and other elements in the ear-clip headphone 100 is not limited in the embodiment of the disclosure.

In some implementable manners, in the ear-clip headphone 100 of the embodiment of the disclosure, when the ear clip part 130 is in the first form, the anterior ear section 131 is convex in a direction away from the ear, and when the ear clip part 130 is in the second form, the anterior ear section 131 is concave in a direction close to the ear, to enable the sound generating part 110 to move in a direction close to the tragus 201 and the ear canal.

It may be understood that, when the ear clip part 130 is in the first form, the anterior ear section 131 is smoothly connected to the posterior ear section 132 to form an arc together. This allows the sound generating part 110 and the main body part 120 to be stably clamped on the ear. When the anterior ear section 131 is pressed to make the anterior ear section 131 concave in the direction close to the ear, thereby switching the ear clip part 130 to the second form, one end of the anterior ear section 131 connected to the posterior ear section 132 remains stationary, so the sound generating part 110 may move in the direction close to the tragus 201 with the other end of the anterior ear section 131 until it abuts against the tragus 201.

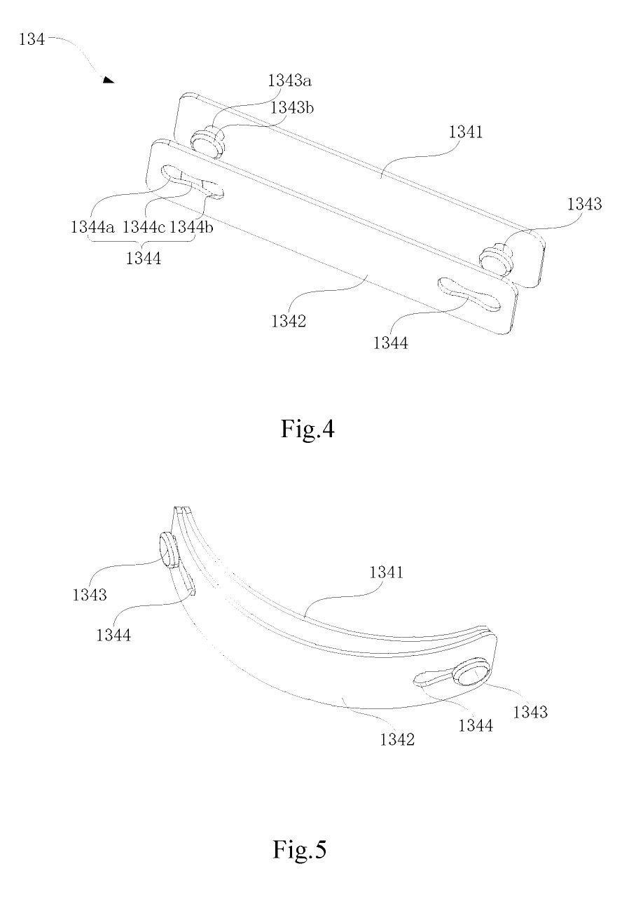

In some implementable manners, referring to FIG. 4 to FIG. 8, the ear clip part 130 according to the embodiment of the disclosure includes: a wrapping piece 133 and a deformation assembly 134, the deformation assembly 134 being arranged in an inner cavity of the wrapping piece 133 and located in the anterior ear section 131, and the deformation assembly 134 including: a first deformation piece 1341 and a second deformation piece 1342, the first deformation piece 1341 and the second deformation piece 1342 both being curved, and the second deformation piece 1342 having a different curvature radius from that of the first deformation piece 1341, the second deformation piece 1342 being arranged in a stacked manner with the first deformation piece 1341 and located on a side of the first deformation piece 1341 away from the ear 200, and opposite ends of the second deformation piece 1342 being respectively slidably connected to opposite ends of the first deformation piece 1341, the second deformation piece 1342 being adapted to drive the first deformation piece 1341 to deform under an external force.

In a specific implementation, by changing the bending directions of the first deformation piece 1341 and the second deformation piece 1342, the ear clip part 130 is adjusted to the first form and the second form. The curvature radius of the second deformation piece 1342 is smaller than the curvature radius of the first deformation piece 1341 in the first form. When the second deformation piece 1342 is pressed, the bending direction of the second deformation piece 1342 changes, which drives the opposite ends of the second deformation piece 1342 to slide outward relative to the opposite ends of the first deformation piece 1341, thereby driving the first deformation piece 1341 to bend in the opposite direction. At this time, the curvature radius of the first deformation piece 1341 is smaller than the curvature radius of the second deformation piece 1342. In this way, through the connection relationship between the opposite ends of the first deformation piece 1341 and the opposite ends of the second deformation piece 1342, the first deformation piece 1341 and the second deformation piece 1342 limit each other to define the bending radian of the anterior ear section 131 in the first form and the second form. Meanwhile, the opposite ends of the first deformation piece 1341 slide with the opposite ends of the second deformation piece 1342, and only by applying an external force to the second deformation piece 1342, the simultaneous deformation of the first deformation piece 1341 and the second deformation piece 1342 may be realized, which makes the operation simple and convenient.

The wrapping piece 133 may be made of a soft material such as rubber, which may change its shape with the deformation of the deformation assembly 134, which is favorable for improving the wearing comfort of the user. The specific material of the wrapping piece 133 is not limited in the embodiment of the disclosure. Meanwhile, the length of the deformation assembly 134 may be one fifth, one quarter, one third or one half of the length of the ear clip part 130, which is suitable for realizing the switching of the ear clip part 130 between the first form and the second form, and is not limited in the embodiment of the disclosure.

In some implementable manners, referring to FIG. 4 to FIG. 6, opposite ends of the first deformation piece 1341 according to the embodiment of the disclosure are respectively provided with a limiting post 1343, opposite ends of the second deformation piece 1342 are respectively provided with a limiting slot 1344 corresponding to the limiting post 1343, and the limiting slot 1344 has a first limiting section 1344a and a second limiting section 1344b that are arranged and communicated in an extending direction of the second deformation piece 1342, and the limiting post 1343 is adapted to move between the first limiting section 1344a and the second limiting section 1344b.

In some embodiments, the limiting post 1343 is inserted into the limiting slot 1344 and slidably connected to the limiting slot 1344, thereby realizing the sliding connection between the opposite ends of the first deformation piece 1341 and the opposite ends of the second deformation piece 1342. The limiting slot 1344 includes the first limiting section 1344a and the second limiting section 1344b communicated with the first limiting section 1344a. In the first form, the limiting post 1343 is located in the first limiting section 1344a, and in the second form, the limiting post 1343 is located in the second limiting section 1344b. The bending radians of the first deformation piece 1341 and the second deformation piece 1342 in the two forms may be defined through the first limiting section 1344a and the second limiting section 1344b.

In some implementable manners, referring to FIG. 4, the limiting slot 1344 according to the embodiment of the disclosure further includes a transition connecting section 1344c located between the first limiting section 1344a and the second limiting section 1344b, and widths of the first limiting section 1344a and the second limiting section 1344b are both greater than a width of the transition connecting section 1344c.

It should be noted that, the width of the transition connecting section 1344c may be set to be slightly larger than the diameter of the limiting post 1343, so as to prevent the limiting post 1343 from sliding arbitrarily between the first limiting section 1344a and the second limiting section 1344b. Only when an external force is applied to the second deformation piece 1342, the limiting post 1343 may slide to the first limiting section 1344a or the second limiting section 1344b through the transition connecting section 1344c, so as to ensure the stability of the ear clip part 130 in the first form and the second form.

In some implementable manners, referring to FIG. 4, the limiting post 1343 according to the embodiment of the disclosure includes a post body 1343a and a limiting head 1343b, the post body 1343a being adapted to pass through the first limiting section 1344a and the second limiting section 1344b, and the limiting head 1343b being arranged at a free end of the post body 1343a and in limiting fit with the limiting slot 1344.

In a specific implementation, the diameter of the limiting head 1343b is larger than that of the first limiting section 1344a and the second limiting section 1344b. The post body 1343a passes through the first limiting section 1344a or the second limiting section 1344b to be connected to the limiting head 1343b. This ensures that the post body 1343a remains inside the limiting slot 1344, preventing the limiting post 1343 from being disconnected from the limiting slot 1344 during the sliding process, which is favorable for ensuring the structural stability of the ear-clip headphone 100.

In some embodiments, the sound generating part 110 may include a first housing 111, and elements such as the speaker unit, the microphone unit, the control apparatus and the like may all be arranged in an inner cavity of the first housing 111. The main body part 120 includes a second housing 121, and a battery may be arranged in the second housing 121.

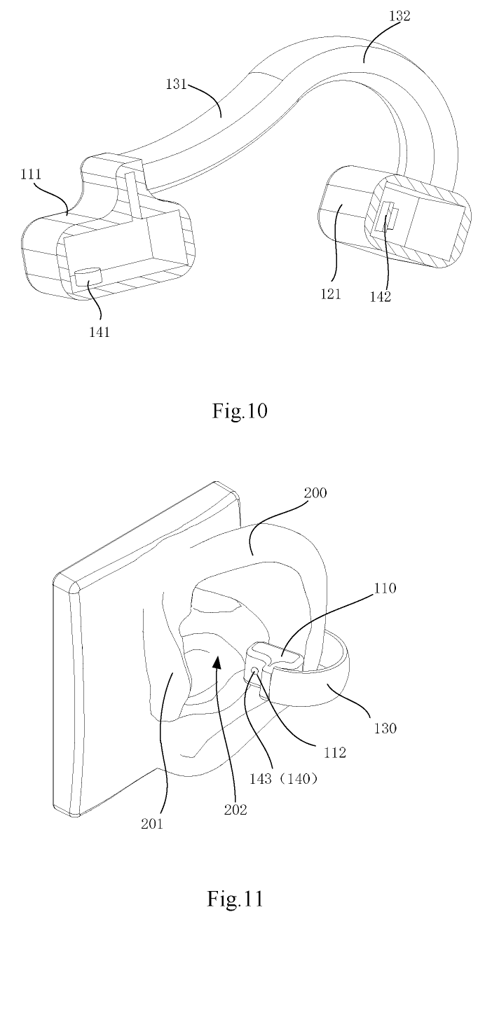

Referring to FIG. 9 and FIG. 10, the form detecting apparatus 140 may include a magnetic member 141 and a hall sensor 142, one of the magnetic member 141 and the hall sensor 142 being arranged in the inner cavity of the first housing 111, and the other being arranged in an inner cavity of the second housing 121. For example, the magnetic member 141 may be arranged in the inner cavity of the first housing 111, and the hall sensor 142 may be arranged in the inner cavity of the second housing 121, that is, the magnetic member 141 is arranged in the sound generating part 110, and the hall sensor 142 is arranged in the main body part 120. Alternatively, the magnetic member 141 may be arranged in the inner cavity of the second housing 121, and the hall sensor 142 may be arranged in the inner cavity of the first housing 111, that is, the magnetic member 141 is arranged in the main body part 120, and the hall sensor 142 is arranged in the sound generating part 110.

The hall sensor 142 is configured to detect a magnetic induction intensity of the magnetic member 141, the hall sensor 142 is connected to the control apparatus, and the control apparatus determines the wearing form of the headphone 100 according to a signal change of the magnetic induction intensity detected by the hall sensor 142.

Specifically, considering that a distance between the hall sensor 142 and the magnetic member 141 when the ear clip part 130 is in the first form is smaller than a distance therebetween when the ear clip part 130 is in the second form, the magnetic induction intensity detected by the hall sensor 142 in the first form is greater than the magnetic induction intensity detected in the second form, that is, the magnetic induction intensity detected by the hall sensor 142 reflects a distance between the sound generating part 110 and the main body part 120, thereby reflecting the wearing form of the headphone 100.

Therefore, the relative position of the hall sensor 142 and the magnetic member 141 may be configured such that when the headphone 100 is in the first form, the magnetic induction intensity detected by the hall sensor 142 is greater than or equal to a first threshold, and when the headphone 100 is in the second form, the magnetic induction intensity detected by the hall sensor 142 is less than the first threshold, or the magnetic induction intensity detected by the hall sensor 142 is zero.

Correspondingly, the wearing form of the headphone may be determined by the following manner: the hall sensor 142 feeds back the detected magnetic induction intensity signal to the control apparatus (such as the processor), and when the control apparatus determines that the magnetic induction intensity is less than the first threshold or is zero, the wearing form of the headphone 100 is determined to be the second form; and when the control apparatus determines that the magnetic induction intensity is greater than or equal to the first threshold, the wearing form of the headphone 100 is determined to be the first form.

In this way, through the cooperation between the hall sensor 142 and the magnetic member 141, the wearing form of the headphone 100 may be detected more accurately, so as to provide a basis for the adjustment of the audio output of the speaker unit.

Referring to FIG. 9, considering that the speaker unit usually includes a magnet, and when the hall sensor 142 is arranged in the sound generating part 110, the magnet of the speaker unit may interfere with the detection accuracy of the hall sensor 142. Therefore, in a specific example, the magnetic member 141 may be arranged in the inner cavity of the first housing 111, and the hall sensor 142 may be arranged in the inner cavity of the second housing 121. In this way, the distance between the hall sensor 142 and the magnet of the speaker unit is increased, which is favorable for eliminating the interference of the magnet of the speaker unit on the hall sensor 142.

In some embodiments, the form detecting apparatus 140 may further include a magnetic conductive cover, and the magnetic conductive cover is arranged on an outer side of the magnetic member 141. In this way, on the one hand, the interference of the magnetic member 141 on the speaker unit may be reduced, and on the other hand, the interference of the magnetic member 141 on other elements in the sound generating part 110, such as the communication module, may be reduced.

In some embodiments, the magnetic member 141 and the speaker unit are respectively arranged on two sides of the control apparatus in the direction of the human coronal axis. In this way, the magnetic member 141 and the speaker unit may be separated by the control apparatus. On the one hand, the distance between the magnetic member 141 and the speaker unit in the direction of the human coronal axis is increased, which helps to reduce the magnetic influence of the magnetic member 141. On the other hand, the control apparatus usually includes a semiconductor component and a shielding cover located on an outer side of the semiconductor component, and the shielding cover also helps to further shield the interference of the magnetic member 141.

In some embodiments, the projection of the magnetic member 141 on the human sagittal plane and the projection of the speaker unit on the human sagittal plane are at least partially staggered. For example, the projections of the magnetic member 141 and the speaker unit on the human sagittal plane may be completely staggered in the front-rear direction, or may be partially staggered. In this way, the distance between the magnetic member 141 and the speaker unit may be further increased, thereby reducing the interference of the magnetic member 141 on the speaker unit.

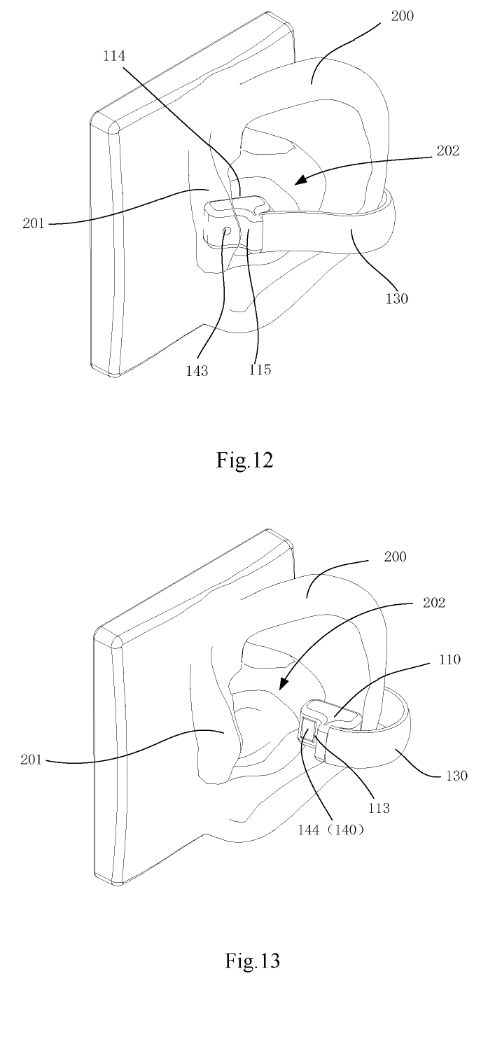

Referring to FIG. 11 and FIG. 12, in addition to the solution of detecting the wearing form of the headphone 100 by using the hall sensor 142 and the magnetic member 141 in the above embodiments, the disclosure further provides some other embodiments, in which the wearing form of the headphone 100 may be detected by using an infrared sensor 143, which is specifically described as follows.

In the present embodiment, the first housing 111 may be provided with a light-transmitting window 112, and the light-transmitting window 112 may be circular, square, triangular or other arbitrary shapes. In the first form, an opening direction of the light-transmitting window 112 is away from the human body, and in the second form, the light-transmitting window 112 is at least partially blocked by the human body.

The form detecting apparatus 140 may further include an infrared sensor 143. Specifically, the infrared sensor 143 is arranged in the first housing 111, and the infrared sensor 143 is adapted to emit and receive infrared rays through the light-transmitting window 112. The infrared sensor 143 is electrically connected to the control apparatus, and the control apparatus determines the wearing form of the headphone 100 according to a signal change of reflected infrared rays received by the infrared sensor 143. Optionally, the infrared rays emitted by the infrared sensor 143 may be infrared pulse rays.

It may be understood that, in the first form, since the opening direction of the light-transmitting window 112 is away from the human body, the infrared rays emitted by the infrared sensor 143 from the light-transmitting window 112 will not be reflected back by the human body (such as the ear area). In this way, when the headphone 100 is in the first form, the infrared sensor 143 cannot receive the reflected infrared signal. On the contrary, in the second form, since the light-transmitting window 112 is at least partially blocked by the human body, the light emitted by the infrared sensor 143 from the light-transmitting window 112 may be reflected back by the human body (such as the ear area). In this way, when the headphone 100 is in the second form, the infrared sensor 143 may receive the reflected infrared signal.

Correspondingly, the wearing form of the headphone may be determined by the following manner: the infrared sensor 143 continuously sends a signal to the control apparatus or sends a signal to the control apparatus according to a preset period, and in the case that the control apparatus receives the reflected infrared signal sent by the infrared sensor 143, the wearing form of the headphone 100 is determined to be the second form; and in the case that the control apparatus does not receive the reflected infrared signal sent by the infrared sensor 143, the wearing form of the headphone 100 is determined to be the first form.

In this way, through the infrared sensor 143, the wearing form of the headphone 100 may be detected more accurately, so as to provide a basis for the adjustment of the audio output of the speaker unit.

In some embodiments, referring to FIG. 12, in the second form, the light-transmitting window 112 is opposite to the tragus 201. That is, when the headphone 100 is in the second form, the tragus 201 may block the light-transmitting window 112, and the infrared light emitted by the infrared sensor 143 through the light-transmitting window 112 may be reflected back by the tragus 201.

In some embodiments, the infrared sensor 143 may include an infrared transmitting unit and an infrared receiving unit. The infrared transmitting unit is configured to emit infrared rays outward from the light-transmitting window 112, and the infrared rays may be infrared pulses. The infrared receiving unit is configured to receive infrared rays reflected back by the human body from the light-transmitting window 112. The infrared receiving unit is electrically connected to the control apparatus, and the control apparatus determines the wearing form of the headphone 100 according to a signal change of the reflected infrared rays received by the infrared receiving unit. In this way, the working principle of the infrared sensor 143 is relatively simple, the work is reliable, and it is easy to implement.

Optionally, the infrared transmitting unit and the infrared receiving unit may be integrated, that is, the infrared sensor 143 is an infrared proximity sensor with both transmitting and receiving functions. In this way, the structure of the infrared sensor 143 is more compact, and the space occupation of the inner cavity of the first housing 111 is reduced.

In some embodiments, as shown in FIG. 12, the first housing 111 includes an inner sidewall 114 facing the human body and an outer sidewall 115 away from the human body in the direction of the human coronal axis, the light-transmitting window 112 may be provided on the outer sidewall 115, and the light-transmitting window 112 is located at a front portion of the outer sidewall 115 in the direction of the human sagittal axis, which may ensure that when the sound generating part 110 moves into the concha cavity 202 and contacts with the tragus 201, the light-transmitting window 112 is blocked by the tragus 201, so as to use the tragus 201 to reflect back the infrared pulses emitted by the infrared sensor 143, thereby realizing the accurate detection of the wearing form of the headphone 100.

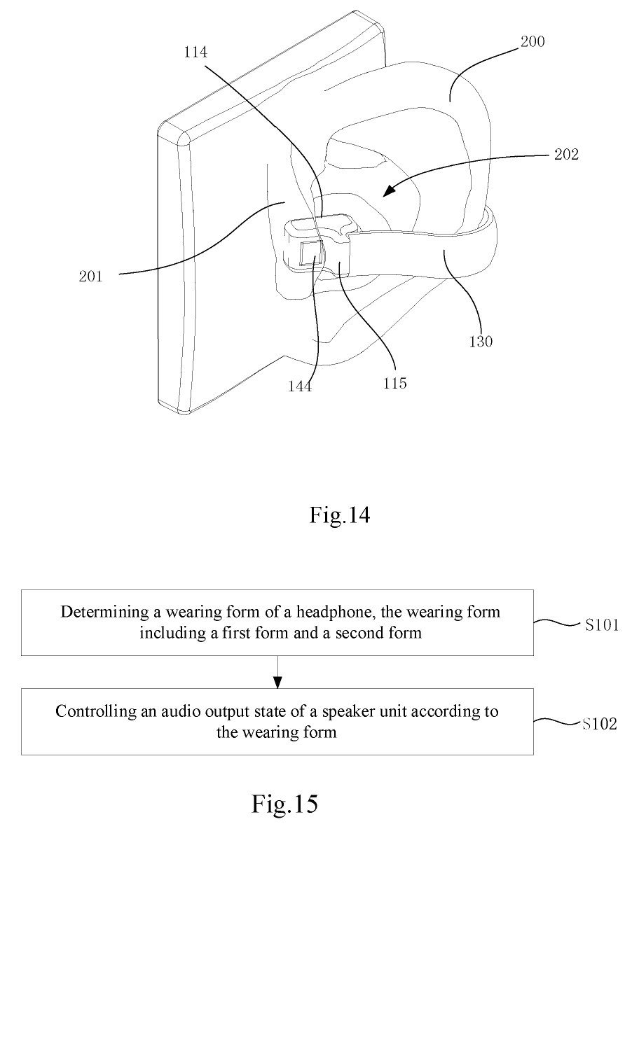

Certainly, the disclosure is not limited to this, and referring to FIG. 13 and FIG. 14, in some other possible embodiments, the form detecting apparatus 140 may further include a capacitive sensor 144. Specifically, the capacitive sensor 144 is separated from the ear in the first form, and the capacitive sensor 144 is in contact with the ear in the second form. The capacitive sensor 144 is electrically connected to the control apparatus, and the control apparatus determines the wearing form of the headphone 100 according to a signal change generated by the capacitive sensor 144.

It may be understood that, in the first form, the capacitive sensor 144 is separated from the ear, and the capacitive sensor 144 is not in contact with the human skin and will not be triggered; and in the second form, the capacitive sensor 144 is in contact with the ear, generating a signal.

Correspondingly, the wearing form of the headphone may be determined by the following manner: the control apparatus continuously receives the signal of the capacitive sensor 144 or receives the signal of the capacitive sensor 144 according to a preset period, and in the case that the control apparatus receives the signal generated by the capacitive sensor 144, the wearing form of the headphone 100 is determined to be the second form; and in the case that the control apparatus does not receive the signal generated by the capacitive sensor 144, the wearing form of the headphone 100 is determined to be the first form.

In this way, through the capacitive sensor 144, the wearing form of the headphone 100 may be detected more accurately, so as to provide a basis for the adjustment of the audio output of the speaker unit.

In some embodiments, referring to FIG. 14, in the second form, the capacitive sensor 144 is in contact with the tragus 201. That is, when the headphone 100 is in the second form, the capacitive sensor 144 is in contact with the skin at the tragus 201, forming a capacitive apparatus and generating an electrical signal. In this way, the capacitive sensor 144 is more likely to come into contact with the human body when the headphone 100 is in the second form, and may also be conveniently arranged on the sound generating part 110.

In some embodiments, as shown in FIG. 13, the first housing 111 may be provided with a mounting window 113, the mounting window 113 may penetrate through the first housing 111, and the capacitive sensor 144 is fixed in the mounting window 113. By arranging the mounting window 113, it is possible to expose the capacitive sensor 144 while ensuring the connection between the capacitive sensor 144 and the control apparatus as well as the power supply apparatus, so as to facilitate the contact with the skin at the tragus 201 to generate the electrical signal when the headphone 100 is in the second form.

In some embodiments, an outer surface of the capacitive sensor 144 is flush with an outer surface of the first housing 111. In this way, it may be ensured that when the headphone 100 is in the second form, the capacitive sensor 144 may come into contact with the skin, so as to ensure the accuracy of the detection result. In addition, the aesthetics of the headphone 100 may also be ensured.

Alternatively, in some other embodiments, the outer surface of the capacitive sensor 144 protrudes from the outer surface of the first housing 111. In this way, when the headphone is in the second form, the capacitive sensor 144 is more likely to come into contact with the skin, thereby ensuring the sensitivity of detection and the accuracy of the detection result.

In some embodiments, the first housing 111 may include an inner sidewall 114 facing a human body and an outer sidewall 115 away from the human body in a direction of a human coronal axis, the mounting window 113 is provided on the outer sidewall 115, and the mounting window 113 is located at a front portion of the outer sidewall 115 in a direction of a human sagittal axis. In this way, it may be ensured that when the sound generating part 110 moves into the concha cavity 202 and contacts with the tragus 201, the capacitive sensor 144 is in contact with the skin at the tragus 201 to generate the electrical signal, thereby realizing the accurate detection of the wearing form of the headphone 100.

It should be noted that, the wearing form of the headphone 100 in the present embodiment may be detected only by the combination of the hall sensor 142 and the magnetic member 141, or may be detected only by the infrared sensor 143, or may be detected only by the capacitive sensor 144, or may be detected by any two or all of the above three methods in combination.

A headphone system according to at least one embodiment of the disclosure is described below.

The headphone system of the present embodiment may include a headphone case and the headphone 100 in the above embodiments.

The headphone case has a storage compartment, the headphone 100 is removably arranged in the storage compartment, and the headphone case may store the headphone 100 and charge the headphone 100.

In the headphone system of the embodiment of the disclosure, by arranging the headphone 100 of the above embodiments, the user’s usage requirements in multiple scenarios may be well satisfied, which is favorable for improving the user experience. Moreover, the headphone case may well store the headphone 100 and charge the headphone 100, thereby ensuring the reusability of the headphone 100.

A headphone control method according to at least one embodiment of the disclosure is described below.

The headphone control method of the present embodiment may be applied to the above-mentioned headphone 100. Specifically, refer to FIG. 15, the headphone control method may include the following steps S101 and S102.

At S101, a wearing form of the headphone 100 is determined, and the wearing form includes a first form and a second form;

Because the headphone 100 has different requirements for sound quality in different forms, for example, in the first form, the headphone 100 is used as an open-back headphone 100, and the bass effect needs to be improved, and in the second form, the headphone 100 is used as an in-ear headphone 100, and the noise reduction effect needs to be improved. Therefore, for the headphone 100 having various forms, in order to ensure that the headphone 100 may output audio corresponding to a wearing form in different wearing forms, it is necessary to first determine the wearing form of the headphone 100. Specifically, the wearing form of the headphone 100 may be determined by the above-mentioned form detecting apparatus 140. The form detecting apparatus 140 may include a combination of a magnetic member 141 and a hall sensor 142, an infrared sensor 143, a capacitive sensor 144, etc.. The respective detection manners of the combination of the magnetic member 141 and the hall sensor 142, the infrared sensor 143 and the capacitive sensor 144 will not be repeated here.

At S102, an audio output state of the speaker unit is controlled according to the wearing form.

After determining the wearing form of the headphone 100, the control apparatus generates an audio adjustment instruction according to the wearing form, and sends the audio adjustment instruction to the speaker unit, and the speaker unit executes the instruction, thereby completing the adjustment of the audio output.

According to the headphone control method of the embodiment of the present disclosure, the audio output of the headphone 100 may be regulated according to the wearing form of the headphone 100, which may ensure that after the headphone 100 switches the wearing mode, the headphone 100 may output audio matching the wearing mode, so as to satisfy the user’s sound quality requirements in different wearing modes, which is favorable for improving the user experience.

In some embodiments, determining the wearing form of the headphone 100 may include: determining the wearing form of the headphone 100 according to a signal change of a magnetic induction intensity detected by a hall sensor 142.

Specifically, the magnetic member 141 is arranged in an inner cavity of the first housing 111, the hall sensor 142 is arranged in an inner cavity of the second housing 121, the hall sensor 142 is configured to detect a magnetic induction intensity of the magnetic member 141, the hall sensor 142 is connected to the control apparatus, and the hall sensor 142 feeds back the detected magnetic induction intensity signal to the control apparatus (such as a processor). When the control apparatus determines that the magnetic induction intensity is less than a first threshold or is zero, the wearing form of the headphone 100 is determined to be the second form; and when the control apparatus determines that the magnetic induction intensity is greater than or equal to the first threshold, the wearing form of the headphone 100 is determined to be the first form.

In some other embodiments, determining the wearing form of the headphone 100 may include: determining the wearing form of the headphone 100 according to a signal change of reflected infrared rays received by an infrared sensor 143.

Specifically, the first housing 111 is provided with a light-transmitting window 112, an opening direction of the light-transmitting window 112 is away from the human body in the first form, and the light-transmitting window 112 is at least partially blocked by the human body in the second form. The infrared sensor 143 is arranged in the first housing 111, and the infrared sensor 143 is adapted to emit and receive infrared rays through the light-transmitting window 112, the infrared sensor 143 is electrically connected to the control apparatus, and the infrared sensor 143 continuously sends a signal to the control apparatus or sends a signal to the control apparatus according to a preset period. In the case that the control apparatus receives a reflected infrared signal sent by the infrared sensor 143, the wearing form of the headphone 100 is determined to be the second form; and in the case that the control apparatus does not receive the reflected infrared signal sent by the infrared sensor 143, the wearing form of the headphone 100 is determined to be the first form.

In some other embodiments, determining the wearing form of the headphone 100 may include: determining the wearing form of the headphone 100 according to a signal change generated by a capacitive sensor 144.

Specifically, the first housing 111 is provided with a mounting window 113, and the capacitive sensor 144 is fixed in the mounting window 113. In the first form, the capacitive sensor 144 is separated from the ear, and the capacitive sensor 144 is not in contact with the human skin and will not be triggered. In the second form, the capacitive sensor 144 is in contact with the ear, generating a signal. The control apparatus continuously receives the signal of the capacitive sensor 144 or receives the signal of the capacitive sensor 144 according to a preset period, and in the case that the control apparatus receives the signal generated by the capacitive sensor 144, the wearing form of the headphone 100 is determined to be the second form; and in the case that the control apparatus does not receive the signal generated by the capacitive sensor 144, the wearing form of the headphone 100 is determined to be the first form.

The present disclosure is not limited to this. In the earphone control method of this embodiment, the wearing form of the headphone 100 may be detected only by the combination of the hall sensor 142 and the magnetic member 141, may be detected only by the infrared sensor 143, may be detected only by the capacitive sensor 144, or may be detected by any two or all of the above three methods in combination.

Hereinafter, a headphone and a headphone system according to at least one embodiment of the present application are described. When an ear clip part of the headphone is in a first form, a sound generating part and a main body part jointly clamp an ear, ensuring good stability and preventing easy falling-off. At this time, a certain gap is left between the sound generating part and an ear canal of the ear, so that the ear canal is not directly pressed, and damage to the ear canal is small. Meanwhile, in the first form, the sound generating part is not in contact with an ear screen, and therefore, sound of an external environment is not completely isolated. The user may hear the sound of the external environment while hearing sound emitted by the sound generating part, so as to maintain vigilance against the environment. However, when the sound of the external environment is relatively loud, audio played by the sound generating part is affected, resulting in serious damage to sound quality, or the sound in the sound generating part is relatively low, making it difficult for the user to hear clearly, which affects use experience of the headphone. In addition, the sound generating part and the main body part may easily cause discomfort to an auricle of the user when clamping the ear for a long time. Therefore, a second form of the ear clip part is provided. In the second form, the sound generating part abuts against the ear screen, and the ear screen may squeeze the sound generating part, and the headphone is fixed on the ear by the sound generating part. At this time, the sound generating part is closer to the ear canal, so that loss of the audio played by the sound generating part during propagation may be reduced, the sound quality may be improved, and meanwhile, the sound of the external environment may be better isolated, so as to ensure that the user may clearly hear the sound played by the sound generating part, which may be applied to a noisy environment.

In addition, when the ear clip part is switched to the first form or the second form according to a wearing manner of the user, a form detecting apparatus detects a form of the ear clip part in real time and transmits a detection result to a control apparatus. The control apparatus intelligently adjusts a sounding state of a speaker unit according to the received detection result. In a general usage scenario, the headphone may be default to be in the first form, so as to provide stable wearing and moderate audio output. When the user desires to obtain higher immersion, the user may adjust the ear clip part to the second form, and at this time, the control apparatus automatically adjusts an audio mode to an immersive mode, such as turning on a noise reduction function, so as to provide richer hearing experience and improve convenience and comfort of use.

Therefore, in the headphone according to at least one embodiment of the disclosure, when the ear clip part is in the first form, the user experiences strong wearing comfort, with less damage to the ear canal, which is suitable for a relatively quiet environment. When the ear clip part is in the first form, the ear clip part exerts less pressure on the user’s auricle, and the audio played by the sound generating part has better sound quality. When the ear clip part is switched between the first form and the second form, the form detecting apparatus and the control apparatus automatically switch a sound emitting state of the speaker unit, thus realizing automatic switching of a usage mode of the ear clip part between the first form and the second form, such as switching from an open mode to the immersive mode (switching from the first form to the second form), or switching from the immersive mode to the open mode (switching from the second form to the first form), which enriches wearing manners and wearing effects of the headphone, improves wearing convenience of the headphone, and enables the user to switch a usage state and the usage mode according to usage scenarios, so as to meet needs of users for various usage scenarios and optimize user experience.

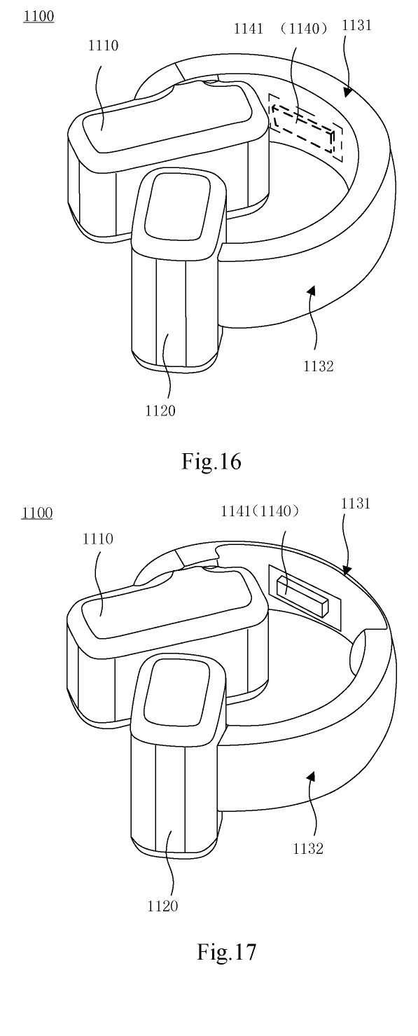

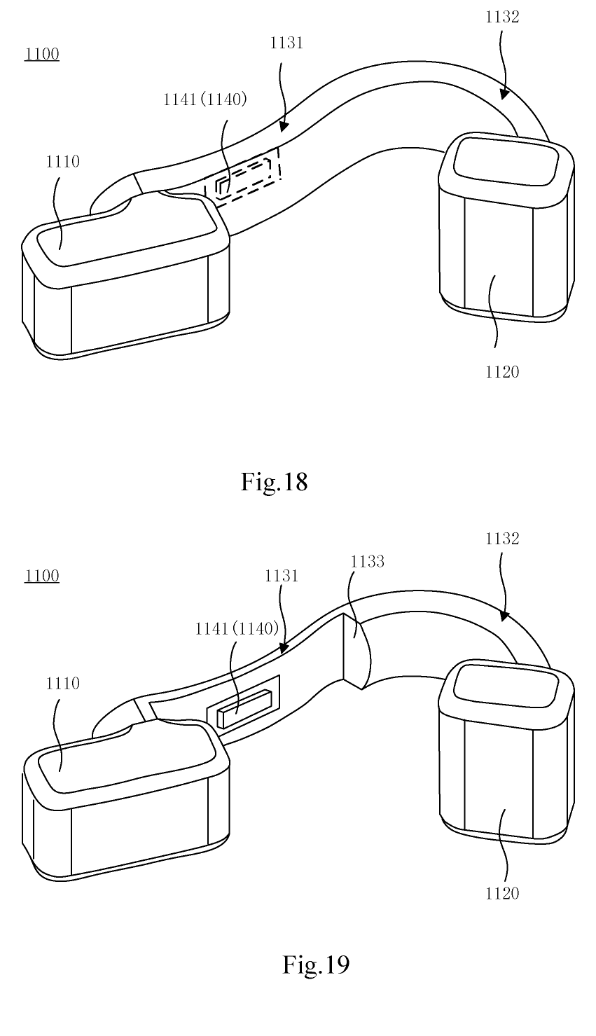

Referring to FIG. 16 to FIG. 23, a headphone 1100 according to at least one embodiment of the present disclosure will be described. The headphone may be an in-ear headphone, an ear-clip headphone, etc.

Referring to FIG. 16 to FIG. 21, a headphone 100 according to at least one embodiment of the present disclosure includes a sound generating part 1110, a main body part 1120, an ear clip part 1130, a form detecting apparatus 1140, and a control apparatus.

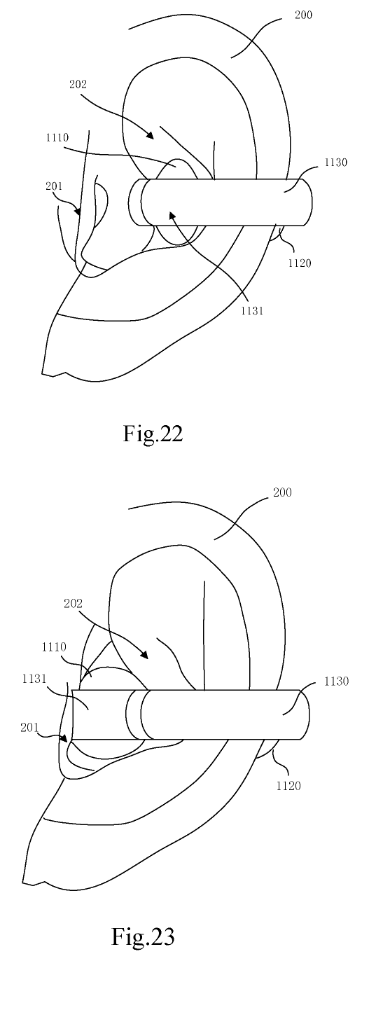

The sound generating part 1110 is used for generating sound, and in the wearing state, the sound generating part 1110 is located at the front side of the ear 200, for example, the sound generating part 1110 is located in the cavum conchae 202 (as shown in FIG. 22). The sound generating part 1110 may include at least a speaker unit and a microphone unit. Optionally, the sound generating part 1110 may be in the shape of a sphere (as shown in FIGS. 22 and 23), a cube, or a cuboid (as shown in FIGS. 16 to 21), and so on.

The speaker unit is mainly used for converting an electrical signal into a sound signal, so as to facilitate the wearer of the headphone 1100 to receive sound. The microphone unit may be used for capturing the sound emitted by the wearer of the headphone 100 and converting the sound signal into an electrical signal, so as to facilitate the transmission to other devices.

It may be understood that, in order to facilitate the sound output, the housing of the sound generating part 1110 may be provided with at least one sound outlet hole (not shown), which is acoustically coupled to the speaker unit. In this way, when the sound generating part 1110 is located at the front side of the ear, the sound may be propagated to the ear hole of the ear through the sound outlet hole, so that the user may hear the corresponding sound information.

In some cases, depending on the volume of the housing of the sound generating part 1110, an electronic control unit may also be provided in the sound generating part 1110. The electronic control unit may include a circuit board, a processor, a communication module, etc. Exemplarily, the circuit board may be a flexible printed circuit (FPC), a printed circuit board (PCB), etc., and the communication module may be a Bluetooth module, a Wifi module, a cellular module, etc. The electronic control unit is respectively connected to the speaker unit and the microphone unit, and the electronic control unit may be used to implement circuit control, control the operation state of the speaker, for example, adjust the volume, control the start and stop of the speaker, control the operation state of the microphone unit, and may also communicate with the outside.

Correspondingly, in the wearing state, the main body part 1120 is located at the rear side of the ear, and the main body part 1120 may be at least used to house a battery. The above-mentioned electronic control unit may also be arranged within the ear clip part 130, which is not limited in the embodiment of the disclosure.

Opposite ends of the ear clip part 1130 are respectively connected to the sound generating part 110 and the main body part 120, and a wire electrically connecting the elements in the main body part 120 and the elements in the sound generating part 110 may be arranged in the ear clip part 130. A flexible circuit board may also be arranged in the ear clip part 130 to control the operation modes of the speaker and the microphone, which may change with the change of the shape of the ear clip part 130.

Further, the ear clip part 130 is configured to be switchable between a first form and a second form. In the first form, the sound generating part 1110 and the main body part 1120 jointly clamp the ear 200. At this time, the ear-clip headphone 1100 is mainly fixed on the ear 200 by the sound generating part 110 and the main body part 120 clamping the auricle. In this form, the sound generating part 1110 is far away from the ear canal, and the ear canal is less pressed, so the damage to the ear canal is small, and the headphone 1100 may be used as an open-back headphone 100, as shown in FIG. 22. In addition, because the sound generating part 1110 is far away from the ear canal at this time, the sound of the external environment may be directly transmitted into the ear canal. Therefore, when the ear clip part 1130 is in the first form, it is more suitable for a quiet environment, and the external sound may be heard without affecting the hearing experience of the user, which is favorable for maintaining vigilant against the external environment or making a timely response to emergencies.

In the second form, the sound generating part 1110 extends into the cavum conchae 202 and abuts against the tragus 201. At this time, the headphone 100 is fixed on the ear 200 mainly through the sound generating part 110, and the ear clip part 130 and the main body part 120 are only in contact with the auricle, playing an auxiliary limiting role. Therefore, the pressure of the ear-clip headphone 1100 on the auricle in the second form is relatively small. Meanwhile, in the second form, the sound generating part 1110 is closer to the ear canal, and the sound played by the speaker of the sound generating part 1110 may be transmitted to the ear canal faster, reducing the loss of the sound during propagation and improving the sound quality, thereby improving the user experience. Meanwhile, because the sound generating part 1110 abuts against the tragus 201, the external sound may be better isolated, so it may be applied to a noisy environment to ensure that the user may clearly hear the sound played by the sound generating part 1110. At this time, the headphone 1100 may be used as an in-ear headphone 1100.

In at least one embodiment of the disclosure, the form of the ear clip part 1130 may be adjusted according to the external environment or the user’s requirements for acoustic effects. When the user is in a quiet environment, or needs to hear the sound of the external environment while listening to the sound played by the headphone 1100, the ear clip part 1130 may be adjusted to the first form, and when the user needs higher sound quality or is in a noisy environment, the ear clip part 1130 may be adjusted to the second form.

In actual use, the wearing mode of the headphone 1100 may also be adjusted for comfort. When the ear clip part 1130 is in the first form, the sound generating part 1110 and the main body part 1120 clamping the auricle of the user for a long time may cause auricle pain to the user. At this time, the ear clip part 1130 may also be adjusted to the second form to relieve the pressure on the auricle. When used as an in-ear headphone 1100 in the second form, the sound generating part 1110 pressing the ear canal orifice for a long time may cause discomfort to the user's ear canal. At this time, the ear clip part 1130 may be adjusted to the first form to keep the sound generating part 1110 away from the ear canal orifice. Therefore, by adjusting the ear clip part 1130 to alternate between the first form and the second form, the issue of local discomfort in the ear 200 caused by the headphone 1100 in a single wearing mode for a long time may be relieved. Additionally, enriching the wearing modes of the headphone 1100 enhances the comfort for the user when wearing the headphone 1100.

In addition, the form detecting apparatus 140 is disposed on the ear clip part 130 and is configured to detect the form of the ear clip part 130, so as to determine whether the headphone 100 is in the first form or the second form. The control apparatus is disposed on the sound generating part 110 and electrically connected to the form detecting apparatus 140, and is at least configured to control the sounding state of the speaker unit according to the detection result of the form detecting apparatus 140. The sounding state may include switching audio modes (such as an open mode and an immersive mode), and may also include adjusting the volume or pausing/playing audio, etc.

Specifically, when the ear clip part 1130 is switched to the first form or the second form according to the wearing manner of the user, the form detecting apparatus 1140 detects the form of the ear clip part 1130 in real time and transmits the detection result to the control apparatus, and the control apparatus intelligently adjusts the sounding state of the speaker unit according to the received detection result, so as to adapt to different usage scenarios and user needs.

For example, when it is determined that the wearing form of the headphone 1100 is the first form, the headphone 100 is used as an open-back headphone 100, and the control apparatus may regulate the audio output of the speaker unit to appropriately improve the bass effect of the headphone 1100; and when it is determined that the wearing form of the headphone 1100 is the second form, the headphone 1100 is used as an in-ear headphone 1100, and the control apparatus may regulate the audio output of the speaker unit to enhance the noise reduction effect of the headphone 1100.

It may be understood that, the control apparatus may be configured to receive a signal fed back by the form detecting apparatus 1140, process the signal, and determine the wearing form of the headphone 1100, and may also be configured to generate an audio adjustment instruction, send the audio adjustment instruction to the speaker unit, and control the speaker unit to execute the instruction. Optionally, the control apparatus may include a processor, and the processor may implement the above-mentioned functions of the control apparatus. The processor may be a central processing unit (abbreviated as CPU), and may also be other general-purpose processor, digital signal processor (abbreviated as DSP), application specific integrated circuit (abbreviated as ASIC), etc. The general-purpose processor may be a microprocessor or any conventional processor, etc.

Optionally, in a general usage scenario, the headphone 1100 may be default to be in the first form, so as to provide stable wearing and moderate audio output. When the user desires to obtain higher immersion, the user may adjust the ear clip part 130 to the second form. At this time, the control apparatus automatically adjusts the audio mode to an immersive mode, such as turning on a noise reduction function, so as to provide richer hearing experience and improve the convenience and comfort of use.

In the headphone 1100 according to at least one embodiment of the present disclosure, when the ear clip part 130 is in the first form, the user enjoys strong wearing comfort with less damage to the ear canal, which is suitable for a relatively quiet environment. Additionally, in the first form, the ear clip part 1130 exerts less pressure on the user's auricle, and the audio played by the sound generating part 110 has better sound quality. When the ear clip part 130 is switched between the first form and the second form, the form detecting apparatus 140 and the control apparatus automatically switch the sound emitting state of the speaker unit, thus realizing the automatic switching of the usage mode of the ear clip part 1130 between the first form and the second form, such as switching from an open mode to the immersive mode (switching from the first form to the second form), or switching from the immersive mode to the open mode (switching from the second form to the first form), which enriches the wearing manners and wearing effects of the headphone 1100, improves the wearing convenience of the headphone 1100, and enables the user to switch the usage state and the usage mode according to the usage scenarios, so as to meet the needs of users for various usage scenarios and optimize the user experience.

In some embodiments, referring to FIG. 16 to FIG. 21, the ear clip part 1130 includes an anterior ear section 1131 located on the front side of the ear 200 and a posterior ear section 1132 located on the rear side of the ear 200, and the anterior ear section 1131 is adapted to deform under an external force to allow the ear clip part 1130 to switch between the first form and the second form.

In a specific implementation, in order to ensure that the main body part 1120 fits against the rear side of the ear 200 in both the first form and the second form, so as to maintain the stability of the headphone 1100, the posterior ear section 1132 needs to be disposed to keep a same shape in the first form and the second form, and the position of the sound generating part 1110 on the front side of the ear 200 is adjusted only by changing the shape of the anterior ear section 1131. The anterior ear section 1131 is disposed to be deformable directly under the external force, so that when the user actually uses the headphone 1100, the user only needs to press the anterior ear section 1131 to complete the switching of the ear clip part 1130 between the first form and the second form, which is convenient to operate and helps the user to adjust at any time, thereby improving the flexibility of the headphone 1100.

In addition, when a circuit board or other elements in the headphone 1100 need to be provided at the ear clip part 1130, they may be provided on the posterior ear section 1132, and the shape of the posterior ear section 1132 is basically kept unchanged, which may prevent the circuit board from being damaged by the deformation of the anterior ear section 1131. The specific layout of the circuit board and other elements within the headphone 1100 is not limited in the embodiment of the present disclosure.

In some embodiments, referring to FIG. 16 to FIG. 21, when the ear clip part 1130 is in the first form, the anterior ear section 1131 is convex in a direction away from the ear 200, and when the ear clip part 1130 is in the second form, the anterior ear section 1131 is concave in a direction toward the ear 200, to allow the sound generating part 1110 to move in a direction toward the ear screen 201 and an ear canal.

It may be understood that, when the ear clip part 1130 is in the first form, the anterior ear section 1131 is smoothly connected with the posterior ear section 1132 to form an arc at one end together, so that the sound generating part 110 and the main body part 120 may be stably clamped onto the ear 200. By pressing the anterior ear section 1131 to allow the anterior ear section 1131 to be concave in the direction toward the ear 200, when the ear clip part 1130 is switched to the second form, one end of the anterior ear section 1131 connected to the posterior ear section 1132 remains stationary, and therefore, the sound generating part 1110 may move in a direction close to the ear screen 201 with the other end of the anterior ear section 1131 until it abuts against the ear screen 201.

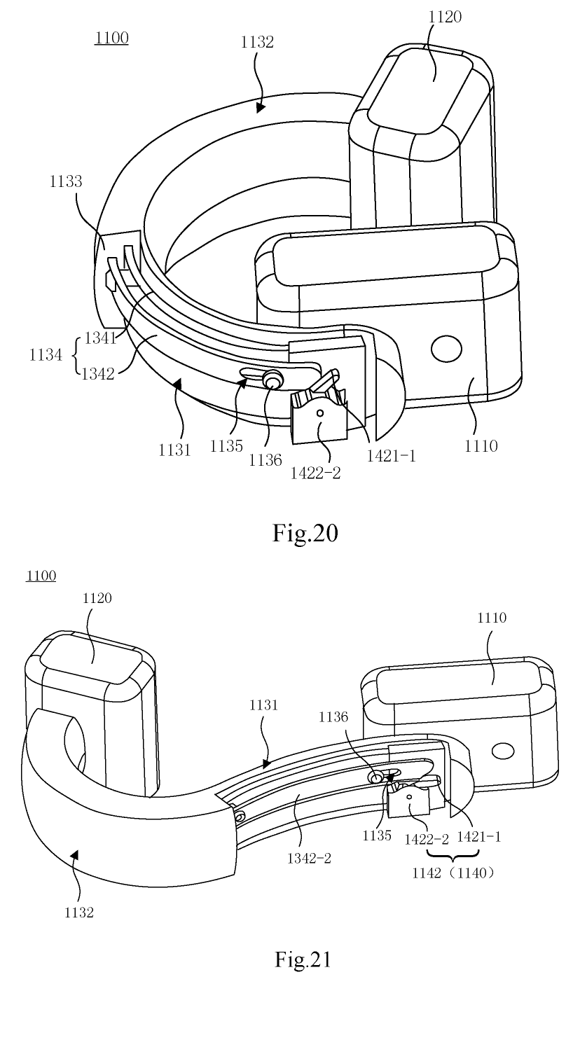

In some embodiments, referring to FIG. 19 to FIG. 21, the ear clip part 130 includes a wrapping piece 133; and a deformation assembly 1134, disposed in an inner cavity of the wrapping piece 133 and located in the anterior ear section 1131, and the deformation assembly 1134 includes a main deformable body 1134-1 and a deformable driving body 1134-2, both of which are curved, and the deformable driving body 1134-2 having a different curvature radius from that of the main deformable body 1134-1, the deformable driving body 1134-2 being arranged in a stacked manner with the main deformable body 1134-1 and located on a side of the main deformable body 1134-1 away from the ear 200, a first end of the main deformable body 1134-1 being fixedly connected to a first end of the deformable driving body 1134-2, and a second end of the main deformable body 1134-1 being slidably connected to a second end of the deformable driving body 1134-2, and the deformable driving body 1134-2 being adapted to slide relative to the main deformable body 1134-1 and drive the main deformable body 1134-1 to deform under an external force.

Optionally, one of the main deformable body 1134-1 and the deformable driving body 1134-2 is provided with a sliding slot 1135, and the other one is fixed with a fixing piece 1136 adapted to be slidably disposed in the sliding slot 1135. When a relative displacement occurs between the main deformable body 1134-1 and the deformable driving body 1134-2, the fixing piece 1136 slides in the sliding slot 1135. This design provides guidance for the sliding of the deformable driving body 1134-2 and ensures the stability during state switching.

In a specific implementation, the ear clip part 1130 is adjusted to the first form or the second form by changing the bending directions of the main deformable body 1134-1 and the deformable driving body 1134-2. In the first form, the deformable driving body 1134-2 has a smaller curvature radius than that of the main deformable body 1134-1. By pressing the deformable driving body 1134-2, the bending direction of the deformable driving body 1134-2 is changed, thereby driving the second end of the deformable driving body 1134-2 to slide relative to an end of the main deformable body 1134-1, and then driving the main deformable body 1134-1 to bend in an opposite direction. At this time, the main deformable body 1134-1 has a smaller curvature radius than that of the deformable driving body 1134-2.

In this way, through the connection and fit connection relationship between the ends of the main deformable body 1134-1 and the deformable driving body 1134-2, the bending direction of the main deformable body 1134-1 is switched. This design only needs to apply an external force to the deformable driving body 1134-2 to realize the simultaneous deformation of the main deformable body 1134-1 and the deformable driving body 1134-2, which is simple and convenient to operate.

The wrapping piece 1133 may be made of a soft material such as rubber, which may change its shape with the deformation of the deformation assembly 1134, and is also beneficial to improving the wearing comfort of the user. The specific material of the wrapping piece 1133 is not limited in the embodiment of the present disclosure. Meanwhile, the length of the deformation assembly 1134 may be one fifth, one fourth, one third or one half of the length of the ear clip part 130, which is preferably to enable the ear clip part 1130 to switch between the first form and the second form, and the embodiment of the present disclosure does not limit thereto.

In some embodiments, referring to FIG. 16 to FIG. 19, the form detecting apparatus 1140 includes a stress sensor 1141, the stress sensor 1141 is disposed on the anterior ear section 1131 and is configured to sense a stress change of the anterior ear section 1131 when the anterior ear section 1131 deforms.

It may be understood that, when the anterior ear section 1131 deforms under an external force, the stress sensor 1141 may sense and measure the stress change caused by the deformation in real time, and the stress change is a direct reflection of the form switching of the ear clip part 1130. Therefore, the stress sensor 1141 may accurately detect the current form of the ear clip part 1130.

The stress sensor 1141 detects the form of the ear clip part 1130 by measuring the stress change of the anterior ear section 1131. Specifically, when the anterior ear section 1131 is convex in the direction away from the ear 200 (in the first form), the stress state felt by the stress sensor 1141 is different from that when the anterior ear section 1131 is concave in the direction toward the ear 200 (in the second form). Because the stress sensor 1141 may directly measure the stress change of the anterior ear section 1131, the accuracy of form detection is significantly improved, and this accuracy helps to ensure that the control apparatus may make a correct response according to the detection result of the form detecting apparatus 1140.

It may be seen that, the stress sensor 1141 actually detects the local bending degree of the anterior ear section 1131, and the greater the bending degree, the higher the value sensed by the stress sensor 1141. In the first form and the second form, the readings of the stress sensor 1141 should be opposite in sign, therefore, the mode of the headphone 1100 may be determined by the sign of the reading of the stress sensor 1141.

In this way, through the design of the stress sensor 1141, more accurate and reliable form switching control is realized, the intelligence level of the headphone 1100 is improved, and more comfortable and convenient listening experience is provided for the user.

In some embodiments, referring to FIG. 16 to FIG. 19, the stress sensor 1141 is disposed in a middle portion of the anterior ear section 1131.

It may be understood that, the middle portion of the anterior ear section 1131 is one of the regions where the deformation of the anterior ear section 1131 is most obvious, and the stress change in the middle portion is more significant in both the first form (convex) and the second form (concave). By placing the stress sensor 1141 at this location, the stress change of the anterior ear section 1131 may be accurately captured, thereby providing reliable form detection information and improving the accuracy and response speed of form detection.

Correspondingly, because the stress sensor 1141 accurately captures the stress change of the anterior ear section 1131, the control apparatus may also quickly respond and adjust the sounding state of the speaker unit. This quick response provides the user with a smoother and more personalized listening experience, which helps to improve the satisfaction of user experience.

In some embodiments, referring to FIG. 16 to FIG. 19, the ear clip part 1130 includes a wrapping piece 1133, and the stress sensor 1141 is wrapped inside the wrapping piece 1133.

It may be understood that, the wrapping piece 1133 provides protection for the stress sensor 1141 against external physical impact and abrasion, which helps to extend the service life of the sensor and ensure its accuracy and stability during long-term use. In addition, the wrapping piece 1133 has a good sealing performance, which may prevent external pollutants such as dust and moisture from entering the interior of the sensor, and helps to keep the sensor clean and dry, thereby ensuring its normal operation.

Correspondingly, this design also enables the stress sensor 1141 to work accurately and stably, and the headphone 1100 may automatically adjust the form and sounding state according to the actual needs of the user, maintain its accuracy and stability, and provide a smoother and more personalized listening experience.

In some embodiments, referring to FIG. 16 to FIG. 19, the stress sensor 1141 includes a strain gauge.

It may be understood that, the strain gauge is a sensor that works based on the principle of resistance change. When the strain gauge is subjected to an external force, the internal resistance wire will deform, resulting in a change in resistance value, and the resistance change is proportional to the stress, so it may be used to measure the magnitude of stress. The strain gauge has the characteristics of high precision and sensitivity, and is capable of accurately measuring a small stress change, and this high-precision measurement capability enables the stress sensor 1141 to capture the subtle deformation of the anterior ear section 1131 during the form switching process.

When the stress piece is deformed under pressure, or when the pressure is greater than a preset value, the strain gauge converts the sensed stress change into an electrical signal for output, and the electrical signal is then transmitted to the control apparatus for processing and analysis, and the control apparatus determines the current form of the ear clip part 130 according to the received electrical signal, and then adjusts the sounding state of the headphone 100 accordingly.

In some embodiments, referring to FIG. 20 and FIG. 21, the form detecting apparatus 140 includes an electronic switch 142 including a first switch part 1142-1 and a second switch part 1142-2. The first switch part 1142-1 is movable relative to the second switch part 1142-2. In the first form, the first switch part 1142-1 is separated from the deformable driving body 1134-2, and the first switch part 1142-1 and the second switch part 1142-2 are disconnected. In the second form, the deformable driving body 1134-2 drives the first switch part 1142-1 to move so that the first switch part 1142-1 and the second switch part 1142-2 form a closed circuit.

It may be understood that, in the first form of the headphone 1100 (the anterior ear section 1131 is convex), the first switch part 1142-1 is separated from the deformable driving body 1134-2. At this time, an open circuit is formed between the first switch part 1142-1 and the second switch part 1142-2, indicating that the headphone 1100 is in the first form. When the headphone 1100 is switched to the second form (the anterior ear section 1131 is concave), the deformable driving body 1134-2 drives the main deformable body 1134-1 to switch from convex to concave under an external force, and drives the first switch part 1142-1 to move, and this movement causes the first switch part 1142-1 to come into contact with the second switch part 1142-2 and form a closed circuit, thereby indicating that the headphone 1100 has been switched to the second form.

When the first switch part 1142-1 and the second switch part 1142-2 form a closed circuit, an electrical signal is triggered and may be transmitted to the control apparatus for identifying the current form of the headphone 1100. After receiving the electrical signal, the control apparatus adjusts the sounding state or other functions of the headphone 1100 according to a preset logic, so as to meet the switching effect of the usage mode of the headphone 1100.

In some embodiments, referring to FIG. 20 and FIG. 21, the first switch part 1142-1 is disposed on a sliding path of the second end of the deformable driving body 1134-2, and the second end of the deformable driving body 1134-2 is an end of the deformable driving body 1134-2 close to the sound generating part 1110.

In this way, when the deformable driving body 1134-2 moves, its second end moves along a preset path and directly interacts with the first switch part 1142-1, and when the form of the headphone 100 changes, this change may be quickly captured by the first switch part 1142-1.

Specifically, when the deformable driving body 1134-2 is in different forms, the movement of its second end will change the relative position with respect to the first switch part 1142-1, and in the first form, an open circuit is formed between the first switch part 1142-1 and the second switch part 1142-2, and in the second form, the movement of the second end will change the position of the first switch part 1142-1, causing the first switch part 1142-1 to come into contact with the second switch part 1142-2 and form a closed circuit. This design ensures the accuracy and response speed of form detection, and also improves the reliability and durability of the headphone 1100.

Optionally, the first switch part 1142-1 may be a pressing handle rotatably disposed on the second switch part 1142-2. The pressing handle has a first position and a second position on the sliding path of the deformable driving body 1134-2, when in the first position, the ear clip part 1130 is in the first form, and when in the second position, the ear clip part 1130 is in the second form. That is, when the ear clip part 1130 is switched from the first form to the second form, the deformable driving body 1134-2 pushes the first switch part 1142-1 to switch from the first position to the second position, so that the first switch part 1142-1 comes into contact with the second switch part 1142-2 and forms a closed circuit.

Optionally, the first switch part 1142-1 is provided with an elastic resetting piece adapted to apply an acting force to the first switch part 1142-1 to make it remain at the first position. It may be seen from the above embodiments that, the first end of the main deformable body 1134-1 is fixedly connected to the first end of the deformable driving body 1134-2, and the second end of the main deformable body 1134-1 is slidably connected to the second end of the deformable driving body 1134-2, that is, the second end of the deformable driving body 1134-2 is slidable toward or away from the first switch part 1142-1.

In this way, when the first form is switched to the second form, the second end slides toward the first switch part 1142-1 and pushes the first switch part 1142-1 to switch to the second position, and when the second form is switched to the first form, the second end slides away from the first switch part 1142-1, the first switch part 1142-1 is released, and automatically switches to the first position under the action of the elastic resetting piece.

In some embodiments, referring to FIG. 20 and FIG. 21, the electronic switch 1142 and the deformation assembly 1134 are arranged along a vertical axis direction of a human body.

It may be understood that, the electronic switch 1142 and the deformation assembly 1134 are arranged along the vertical axis direction of the human body (i.e., from top to bottom), which is convenient for the user to operate, and also improves the response speed and functionality of the headphone 1100. In addition, this layout conforms to ergonomic principles, reduces the pressure of the headphone 1100 on the head and the ear 200, and ensures the natural fit and comfort of the headphone 1100 when worn by the user. This design also helps to reduce the overall thickness, improve the aesthetics of the headphone 1100, and make it more portable and easy to store.

In some embodiments, referring to FIG. 20 and FIG. 21, the electronic switch 1142 is wrapped inside the wrapping piece 1133.

It may be understood that, the wrapping piece 1133 may effectively prevent dust and moisture from entering the interior of the electronic switch 1142, so as to prolong the service life of the electronic switch 1142 and prevent the failure caused by short circuit, and this design is particularly important especially in outdoor or humid environments.

Optionally, the wrapping piece 1133 may be made of a soft and elastic material, such as silica gel or rubber, which is capable of absorbing impact force and preventing the electronic switch 1142 from being scratched or damaged.

By wrapping the electronic switch 1142 inside, the appearance of the headphone 1100 becomes more concise and streamlined, and the aesthetics of the headphone 1100 is improved. In addition, this design also enhances the durability of the electronic switch 1142, and the wrapping piece 1133 may also play a certain protective role even if it is subjected to external impact or wear during use.

At least one embodiment of the disclosure also provides a headphone system including the above headphone 1100.

In the headphone system, through the design of the headphone 1100, the automatic switching of the usage mode in the first form and the second form is realized, such as switching from an open mode to an immersive mode (switching from the first form to the second form), or switching from the immersive mode to the open mode (switching from the second form to the first form), which enriches the wearing manners and wearing effects of the headphone 1100, improves the wearing convenience of the headphone 1100, and enables the user to switch the usage state and the usage mode according to the usage scenarios, so as to meet the needs of users for various usage scenarios and optimize the user experience.

Hereinafter, a headphone according to at least an embodiment of the present disclosure is described. A main body of the headphone includes a first main body part and a first deformation part. The first deformation part is connected to a sound generating part of the headphone, is deformable and has a first wearing state and a second wearing state. The deformation and state retention of the first deformation part are controlled by a locking piece. For example, when the locking piece is connected with the first deformation part, the first deformation part is locked. At this time, the first deformation part is not deformable and is in the first wearing state, so that the distance between the sound generating part and an ear canal orifice is increased, thereby improving the wearing comfort of the headphone. When the locking piece is not connected with the first deformation part, the first deformation part is unlocked. At this time, the first deformation part is deformable and is in the second wearing state, so that the distance between the sound generating part and the ear canal orifice is reduced, thereby making the headphone a semi-in-ear headphone or an in-ear headphone, and improving the sound quality of the headphone. In this way, the adjustability of the first deformation part allows the headphone to better adapt to the ear canal shapes and sizes and actual needs of different users, thereby allowing the headphone to freely switch between wearing comfort and sound quality.

In order to make the above objects, features, and advantages of the embodiments of the disclosure more comprehensible, the technical solutions in the embodiments of the present disclosure will be described clearly and completely with reference to the drawings in the embodiments of the present application. Obviously, the described embodiments are part of the embodiments of the present disclosure, but not all of the embodiments. All other embodiments obtained by those skilled in the art based on the embodiments in the present disclosure without creative efforts belong to the protection scope of the present disclosure.

At least an embodiment of the present disclosure provides a headphone 1000, which may be an ear-clip headphone.

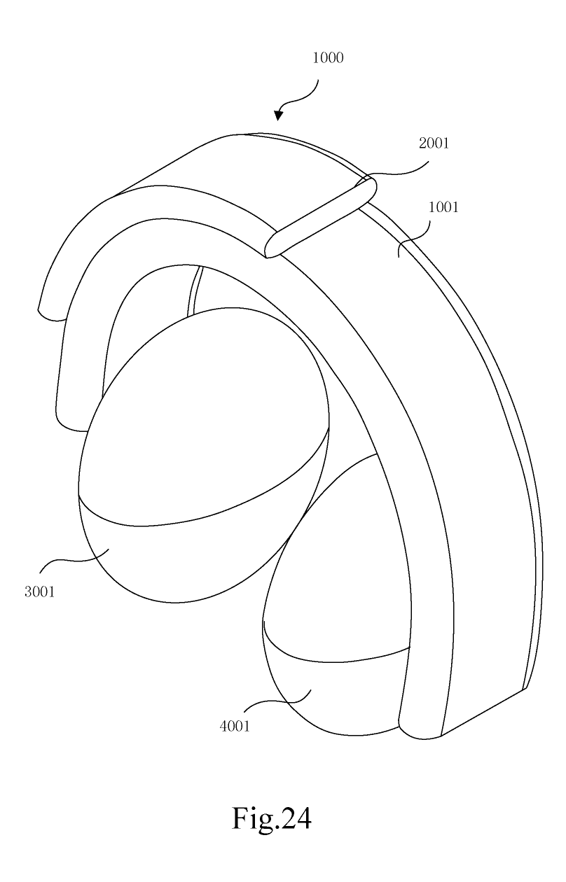

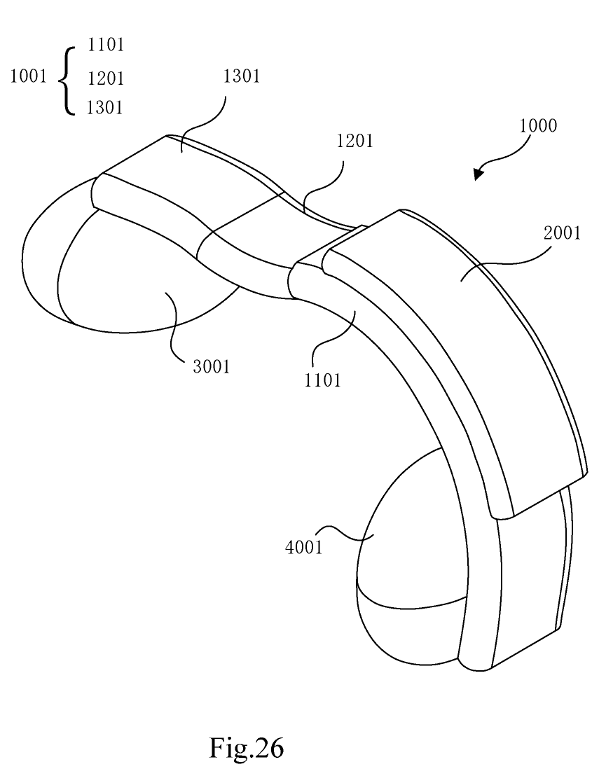

Referring to FIGS. 24 and 26, at least an embodiment of the present disclosure provides a headphone 1000 including a main body 100, and the main body 100 is a main component of the headphone 1000, which is used to connect a sound generating part 300 and a balancing part 400 of the headphone 1000, and to route wires of the headphone 1000.

In a wearing state, the main body 1001 straddles a helix 211 of the ear 200 and clamps the helix 211, so that the headphone 1000 is an ear-clip headphone.

In this example, the balancing part 400 and the sound generating part 300 are respectively located on opposite sides of the main body 100. In this way, by placing a battery of the headphone 1000 in the balancing part 4001, the weight of the balancing part 4001 and the weight of the sound generating part 3001 cooperate with each other, which facilitates the realization of the overall weight balance of the headphone 1000. The user may feel a more balanced force when wearing the headphone, which reduces the oppression or discomfort caused by uneven weight distribution, thereby improving the comfort of long-term wearing. At the same time, the design of the balancing part 4001 also helps to enhance the stability of the headphone 1000 on the head and reduce the risk of accidental falling off.

Referring to FIG. 26, the main body 1001 includes at least a first main body part 1101 and a first deformation part 1201, and the first main body part 1101 and the first deformation part 1201 are connected to each other, so that a portion of the region in the main body 1001 is deformable, so as to change the shape of the main body 1001. It should be noted that the first main body part 1101 and the first deformation part 1201 may be connected by directly connecting an end of the first main body part 1101 to an end of the first deformation part 1201, or by connecting the first main body part 1101 and the first deformation part 1201 through an adapter.

The first deformation part 1201 is adapted to be connected to the sound generating part 3001 of the headphone 1000, in other words, an end of the first deformation part 1201 facing away from the first main body part 1101 is connected to the sound generating part 3001. It should be noted that the connection in this embodiment may be understood as a direct connection or an indirect connection.

In view of the fact that the sound generating part 3001 is connected to the first deformation part 1201 in this embodiment, when the shape of the first deformation part 1201 is changed, the position of the sound generating part 3001 relative to the ear canal orifice 18 is changed at the same time, thereby allowing the headphone 1000 to freely switch between wearing comfort and sound quality.

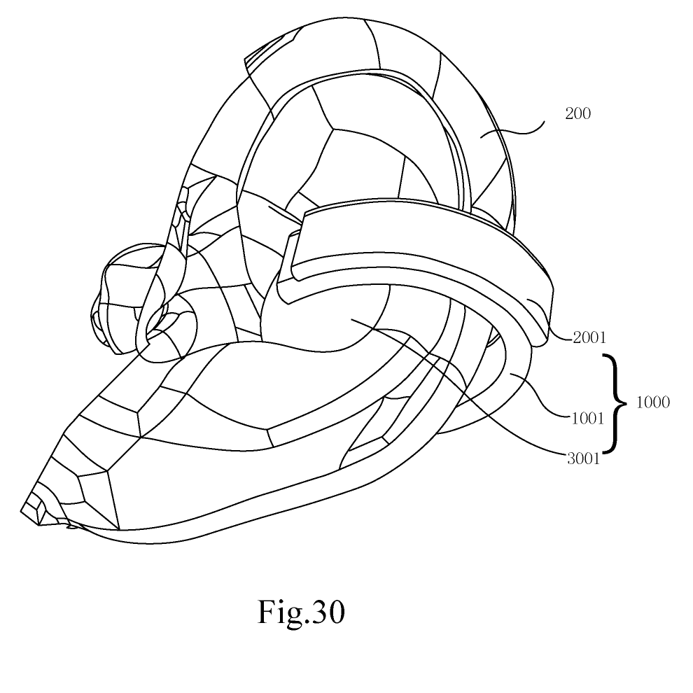

Exemplarily, the first deformation part 1201 includes a first wearing state and a second wearing state, and a distance between the sound generating part 3001 and the ear canal orifice 18 in the first wearing state is greater than that in the second wearing state. In other words, referring to FIG. 30, in the first wearing state, the distance between the sound generating part 3001 and the ear canal orifice 18 is relatively large. At this time, the headphone 1000 may be an open-back headphone, which may reduce damage of the sound generating part 3001 to the ear canal and improve wearing comfort of the headphone 1000.

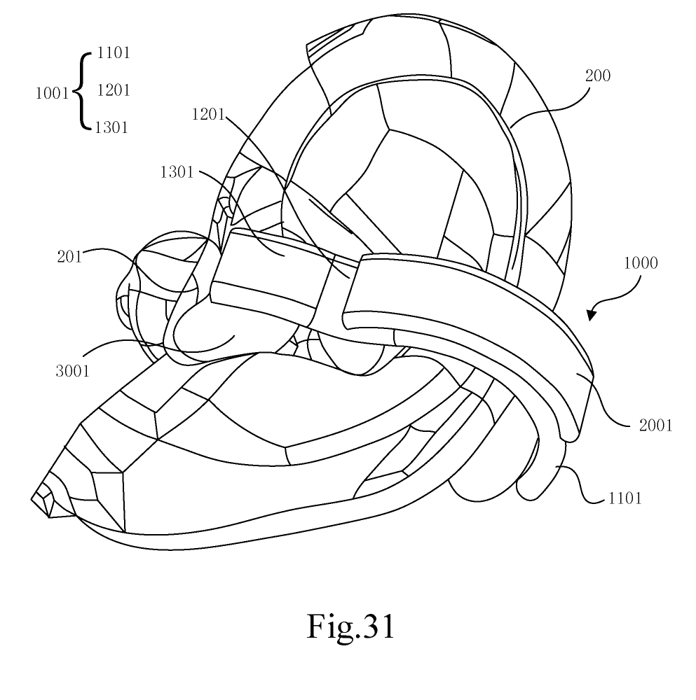

Referring to FIG. 31, in the second wearing state, the distance between the sound generating part 300 and the ear canal orifice 18 is relatively small. At this time, the headphone 1000 may be a semi-in-ear headphone or an in-ear headphone, which may reduce the distance between the sound generating part 3001 and the ear canal orifice 18, thereby improving the sound quality of the headphone 1000.

It should be understood that the sound quality in this embodiment may include the volume of the headphone and the clarity of the sound quality of the headphone.

In order to ensure that the first deformation part 1201 is freely switchable between the first wearing state and the second wearing state, the headphone 1000 according to at least an embodiment of the present disclosure further includes a locking piece 2001, one end of the locking piece 2001 is movably connected to the first main body part 1101, and the other end of the locking piece 2001 is selectively connected to the first deformation part 1201, so that the first deformation part 1201 and the locking piece 2001 can switch between a locked state and an unlocked state.

The selective connection may be understood as that the locking piece 2001 is connected to the first deformation part 1201 in some states, and the locking piece 2001 is not connected to the first deformation part 1201 in other states.

Exemplarily, when the locking piece 2001 is connected to the first deformation part 1201, the first deformation part 1201 is locked. At this time, the first deformation part 1201 is not deformable and is in the first wearing state, so that the distance between the sound generating part 3001 and the ear canal orifice is increased, thereby making the headphone 1000 an open-back headphone, and improving the wearing comfort of the headphone 1000.

When the locking piece 2001 is not connected to the first deformation part 1201, the first deformation part 1201 is unlocked, to release the fixation of the first deformation part 1201. At this time, the first deformation part 120 is deformable and is in the second wearing state, so that the distance between the sound generating part 3001 and the ear canal orifice is reduced, thereby improving the sound quality of the headphone 1000.

In this way, in this embodiment, the provision of the locking piece 2001 allows the first deformation part 1201 to be adjustable, so that the headphone 1000 may be more flexible to adapt to shapes and sizes of the ear canal as well as actual needs of different users, thereby allowing the headphone 1000 to freely switch for wearing comfort or sound quality.

In an embodiment of the present disclosure, the balancing part 4001 is connected to an end of the first main body part 1101 facing away from the sound generating part 3001. When the first deformation part 1201 is in the first wearing state, the sound generating part 3001 and the balancing part 4001 jointly clamp the ear 200, to form a stable wearing structure, which may effectively prevent the headphone 1000 from slipping or loosening while being worn, and may still keep a stable wearing state especially when the user is engaged in strenuous exercise or frequent head movements, thereby providing users with a continuous and uninterrupted hearing experience.

In other embodiments, when the first deformation part 1201 is in the first wearing state, the sound generating part 3001 at least partially abuts against the cavum conchae and jointly clamps the ear 200 with the balancing part 4001 located at the rear side of the ear, which further improves the wearing stability of the headphone 1000.

When the first deformation part 1201 is in the second wearing state, the sound generating part 3001 may extend below the tragus, that is, the sound generating part 3001 is stuffed below the tragus, and the sound generating part 3001 is similar to an earplug of an in-ear headphone. In this way, on the premise that the distance between the sound generating part 3001 and the ear canal orifice 18 is ensured to be shortened, the headphone 1000 may also be fixed onto the ear, thereby improving the wearing stability of the headphone 1000.

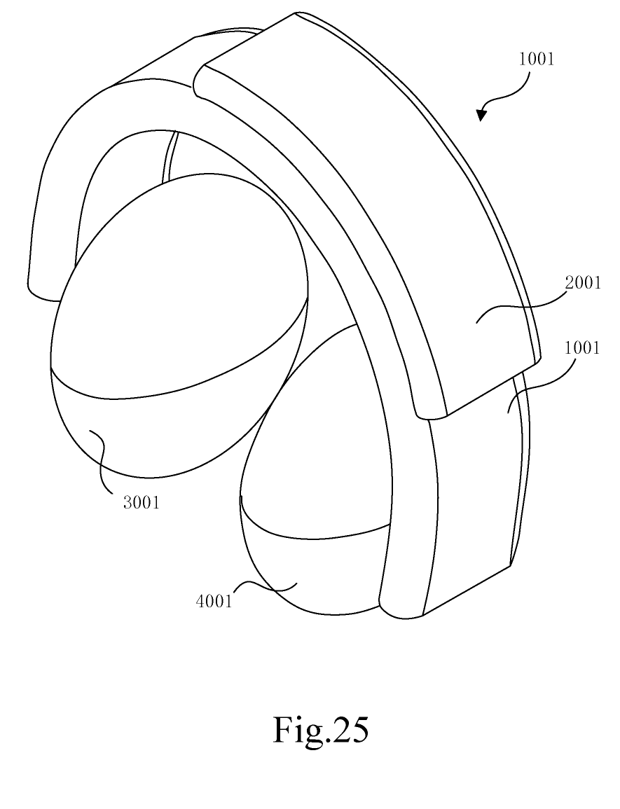

In a possible implementation, referring to FIGS. 25 and 26, when the locking piece 2001 moves in a direction away from the first deformation part 1201, the locking piece 2001 is separated from at least a portion of the first deformation part 1201 so that the first deformation part 1201 and the locking piece 2001 are in the unlocked state.

Referring to FIG. 24, when the locking piece 2001 moves in a direction toward the first deformation part 1201, the locking piece 2001 is connected to the first deformation part 1201 so that the first deformation part 1201 and the locking piece 2001 are in the locked state.

In this way, by simply moving the locking piece 2001, the locking and unlocking of the first deformation part 1201 and the locking piece 2001 may be easily realized. This design allows the headphone 1000 to quickly adapt to different wearing needs, thereby improving the efficiency of wearing the headphone.

It should be understood that the locking piece 2001 and the first deformation part 1201 may be connected in other ways, for example, the locking piece 2001 may also be directly engaged with the first deformation part 1201. For example, when the shape of the first deformation part 1201 needs to be fixed, the locking piece 2001 may be engaged with the first deformation part 1201. For another example, when the shape of the first deformation part 1201 needs to be deformed, the locking piece 2001 may be removed, and then the shape of the first deformation part 1201 may be adjusted.

In an embodiment in which the locking piece 2001 is movably connected to the first main body part 1101, in an example, one end of the locking piece 2001 is slidably disposed on the first main body part 1101. In this way, during the movement of the locking piece 2001, the locking piece 2001 may be supported by the first main body part 1101, which ensures the stability and accuracy of the locking and unlocking of the locking piece 2001.

In order to realize the sliding connection between the locking piece 2001 and the first main body part 1101, a sliding protrusion and a sliding groove may be matched with each other. Exemplarily, one of the locking piece 2001 and the first main body part 1101 is provided with a sliding protrusion (not shown), the other of the locking piece 2001 and the first main body part 1101 is provided with a sliding groove (not shown), and the sliding protrusion is slidably disposed in the sliding groove.

The close fit between the sliding protrusion and the sliding groove provides precise guidance for the locking piece 2001, which ensures the stability and accuracy of the locking piece 2001 during movement, and avoids possible deviation or shaking of the locking piece during sliding. At the same time, the design of the sliding protrusion and the sliding groove is relatively simple, which is easy to manufacture and process, and reduces the production cost.

In another example, one end of the locking piece 2001 is rotatably connected to the first main body part 1101. For example, one of the locking piece 2001 and the first main body part 1101 is provided with a rotating groove, and the other of the locking piece 2001 and the first main body part 1101 is provided with a rotating shaft. The rotation of the rotation shaft in the rotation groove enables the movable connection between the locking member 2001 and the first main body part 1101.

It should be understood that when the locking piece 2001 needs to be separated from the first main body part 1101, the locking piece 2001 may be controlled to rotate around the rotating shaft, to unlock the locking piece 2001. At this time, the rotation angle of the locking piece 2001 may be freely set according to the actual situation. For example, the rotation angle of the locking piece 2001 may be 180 degrees, so that the rotated locking piece 2001 may be disposed in contact with the first main body part 1101. In this way, the locking piece 2001 does not occupy extra space, which improves the space utilization and the aesthetics of the headphone 1000.

In a possible implementation, when the first deformation part 1201 and the locking piece 2001 are in the locked state, the locking piece 2001 is located on the first deformation part 1201 and is disposed in contact with the first deformation part 1201. In other words, the shape of the locking piece 2001 is adapted to the shape of the first deformation part 1201, so that the surfaces of the locking piece 2001 and the first deformation part 1201 that are opposite to each other are disposed in contact with each other, which may ensure the stability of the locked state, reduce the locking looseness caused by external force, and prevent the shape of the first deformation part 1201 from being changed during use, thereby ensuring the wearing comfort and sound quality of the headphone 1000. It should be understood that the locking piece 2001, being located on the first deformation part 1201 and being disposed in contact with the first deformation part 1201, may be the locking piece 2001 being completely in contact with the first deformation part 1201, to prevent the first deformation part 1201 from being deformed in the first wearing state.

The sound generating part 3001 and the first deformation part 1201 may be directly connected or indirectly connected. Exemplarily, the headphone 1000 further includes a second main body part 1301 disposed on a side of the first deformation part 1201 facing away from the first main body part 1101. That is, the sound generating part 3001 is connected to the first deformation part 1201 through the second main body part 1301. The second main body part 1301 may be made of a hard material, which may facilitate the sound generating part 3001 to maintain a specific shape, avoid the squeezing between the sound generating part 3001 and the tragus or the cavum conchae of the ear, and improve the wearing comfort of the headphone 1000.

In an embodiment of the present disclosure, the other end of the locking piece 2001 is selectively connectable to the second main body part 1301, so that both the locking piece 2001 and the second main body part 1301 are made of hard materials, which may facilitate the connection between the locking piece 2001 and the second main body part 1301.

When the headphone 1000 includes the first deformation part 1201 and the second main body part 1301, and the first deformation part 1201 and the locking piece 2001 are in the locked state, the locking piece 2001 is disposed in contact with the first deformation part 1201 and at least a portion of the second main body part 1301. That is, the locking piece 2001 is disposed in contact with the first deformation part 1201 and a portion of the second main body part 1301, or the locking piece 2001 is disposed in contact with the first deformation part 1201 and the entire second main body part 1301. In this way, on the premise that the stability of the connection between the first deformation part 1201 and the locking piece 2001 is ensured, the design flexibility of the headphone 1000 may also be improved.

The connection between the other end of the locking piece 2001 and the second main body part 1301 may be selected in a variety of ways.

In an example, the shape of the opposite surfaces of the locking piece 2001 and the second main body part 1301 match with each other. The locking between the locking piece 2001 and the second main body part 1301 may be realized through their mutual fitting and abutting.

In another example, the locking piece 2001 and the second main body part 1301 may also be connected by a magnetic piece. For example, a first magnetic part is provided in the locking piece 2001, a second magnetic part is provided in the second main body part 1301, and the first magnetic part and the second magnetic part have opposite polarities, so that the stable connection between the locking piece 2001 and the second main body part 1301 may be realized by using the principle that opposite magnetic poles attract each other. During use, only the locking piece 2001 needs to be close to the second main body part 1301, and the magnetic force will automatically attract and firmly connect the two pieces together. This connection manner is fast and convenient, and greatly improves the user experience.

In a possible implementation, one of the locking piece 2001 and the first main body part 1101 is provided with a locking groove 1501, and the other of the locking piece 2001 and the first main body part 1101 is provided with an elastic protrusion 1601. When the elastic protrusion 1601 is engaged with the locking groove 1501, the first deformation part 1201 and the locking piece 2001 are in the locked state.

In order to facilitate the detailed description of the connection between the locking piece 2001 and the first main body part 1101, the locking groove 1501 is provided in the first main body part 1101, and the elastic protrusion 1601 is provided in the locking piece 2001 as an example for detailed description.

The elastic protrusion 1601 is movable in a direction toward the first main body part 1101 so that the elastic protrusion 1601 protrudes from the locking piece 2001. The elastic protrusion 1601 is also movable in a direction away from the first main body part 1101 so that the elastic protrusion 1601 retracts into the locking piece 2001. Exemplarily, the elastic protrusion 1601 may include an elastic piece and a protrusion connected to the elastic piece, the locking piece 2001 may include an inner cavity and a through hole communicated with the inner cavity, and the elastic protrusion is disposed in the inner cavity and is movable out of or into the inner cavity.

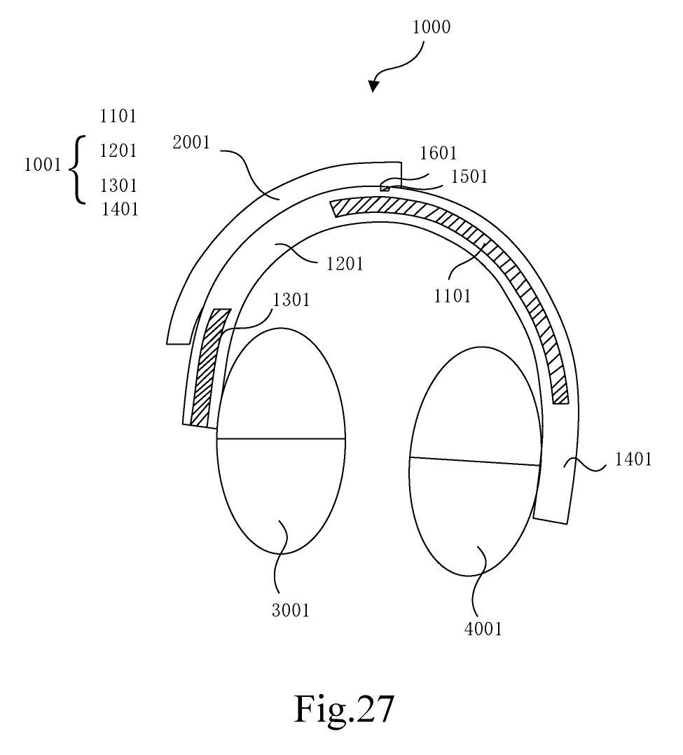

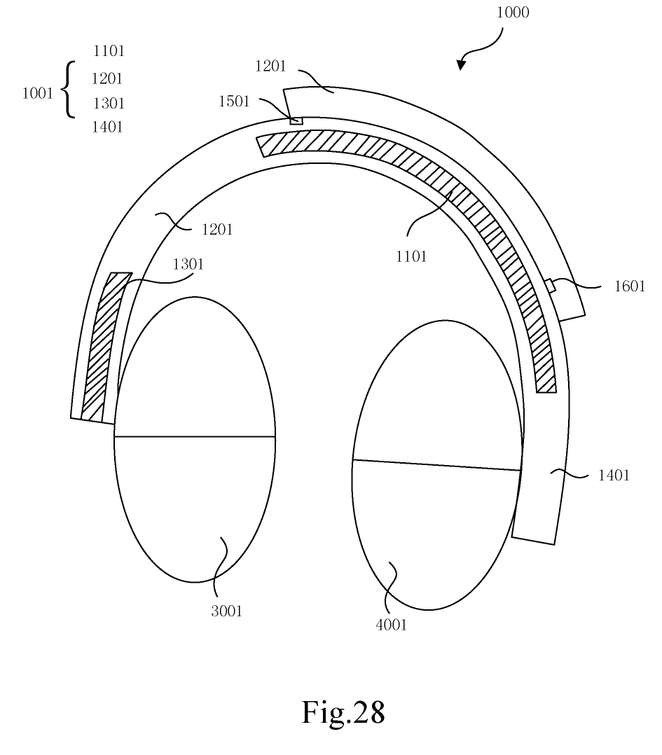

Referring to FIG. 27, in the first wearing state, the elastic protrusion 1601 protrudes from the locking piece 2001 and is engaged with the locking groove 1501. When it is necessary to switch from the first wearing state to the second wearing state and an external force is applied to the locking piece 2001, the elastic protrusion 1601 is disengaged from the locking groove 1501, and under the squeezing action of the first main body part 1101, the elastic protrusion 1601 retracts into the locking piece 2001 and moves in a direction away from the first deformation part 1201 with the locking piece 2001, as shown in FIG. 28.

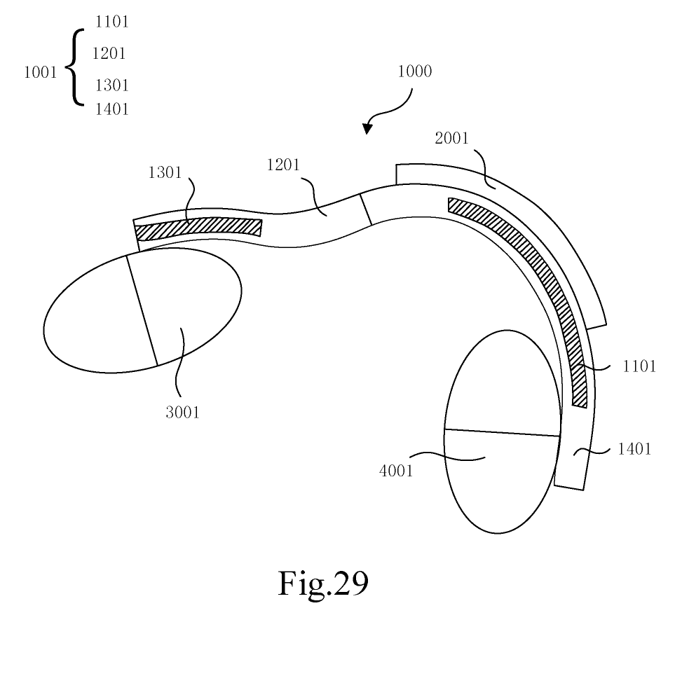

When it is necessary to switch from the first wearing state to the second wearing state, that is, i.e., from the state shown in FIG. 29 to the state shown in FIG. 27, and an external force is applied to the locking piece 2001, the locking piece 2001 is moved toward the first deformation part 1201, and when the elastic protrusion 1601 of the locking piece 2001 is moved to the locking groove 1501, the elastic piece is no longer squeezed. Under the elastic restoring force of the elastic piece, the elastic protrusion 1601 protrudes from the inner cavity of the locking piece 2001 and is clamped in the locking groove 1501, as shown in FIG. 26.

In an embodiment of the present disclosure, the elastic protrusion 1601 may protrude from the locking piece 2001 or retract into the locking piece 2001 as needed, which allows the headphone 1000 to be flexibly switched between different wearing states. Users may switch the wearing state through simple operations (such as applying an external force), without complex adjustment or additional tools.

It should be understood that the sidewall of the locking groove 1501 may be a guide wall. In this way, the guide wall provides a clear path for the elastic protrusion 1601, enabling it to more accurately locate and slide into the locking groove 1501. In addition, the guide wall may also reduce the friction and resistance between the elastic protrusion 1601 and the groove wall during sliding in or out, reduce wear between the elastic protrusion 1601 and the groove wall of the locking groove 1501, and prolong the service life of the headphone 1000.

In an embodiment of the present disclosure, the main body 1001 may further include a second deformation part 1401 disposed between the balancing part 4001 and the first main body part 1101, that is, the balancing part 4001 is connected to the first main body part 1101 through the second deformation part 1401. In this way, during wearing the headphone 1000, the setting position of the balancing part 4001 may be finely adjusted according to the shape and size of the ears of different users, so that the balancing part 4001 may better fit the rear side of the ear, thereby increasing the clamping force of the balancing part 4001 and the sound generating part 3001 on the helix, and improving the stability of the headphone 1000.

In addition, the flexible design of the second deformation part 1401 allows the balancing part 4001 to be adjusted adaptively according to the ear contours of different users. This adaptive adjustment reduces the pressure on the ears caused by the headphone 1000 and improves the wearing comfort, allowing users to maintain a pleasant experience when wearing the headphone for a long time.

It should be understood that each part of the main body 1001 may be separately prepared and then assembled together. Beside this, there may also be other ways.

In a possible implementation, the headphone 1000 includes a flexible housing, the first main body part 1101 and the second main body part 1301 are disposed in the flexible housing at a distance from each other, and a region of the flexible housing between the first main body part 1101 and the second main body part 1301 constitutes the first deformation part 1201.

In other words, the main body 1001 of the headphone 1000 is prepared by a double-shot injection molding process. Exemplarily, a material with a relatively large hardness is first injected to form the first main body part 1101 and the second main body part 1301, and then corresponding components are disposed on the first main body part 1101 and the second main body part 1301. The materials of the first main body part 1101 and the second main body part 1301 include any of acrylonitrile-butadiene-styrene copolymer (ABS), polystyrene (PS) and polymethyl methacrylate (PMMA).

Then, using the second injection molding process, injection molding is performed again on the outside of the first main body part 1101 and the second main body part 1301 and in the region between the first main body part 1101 and the second main body part 1301, to form the entire flexible housing. The flexible housing is made of a soft material. The region between the first main body part 1101 and the second main body part 1301 constitutes the first deformation part 1201. The flexible housing may be made of any of thermoplastic elastomer (TPE), thermoplastic rubber (TPR) or thermoplastic polyurethane (TPU).

It should be noted that when the main body 1001 of the headphone 1000 includes the second deformation part 1401, a region of the flexible housing located on a side of the first main body part 1101 facing away from the second main body part 1301 constitutes the second deformation part 1401.

In the present embodiment, through the molding and fitting manner between the hard materials and the soft materials, as well as the ingenious cooperation with the locking piece 2001, the headphone 1000 may be freely switched between an open-back headphone and an in-ear headphone, which realizes the switching of functional scenarios of acoustic effects, and takes into account the advantages of the respective product types of the open headphone and the in-ear headphone. The in-ear headphone includes a semi-in-ear headphone and a full-in-ear headphone.

In addition, the headphone 1000 also has the advantages of simple processing, molding and manufacturing principles, and miniaturized and lightweight wearing products.

Finally, it should be noted that those skilled in the art will readily figure out other implementation solutions of the present invention after considering the description and practicing the invention disclosed herein. The present invention is intended to cover any variations, purposes or adaptive changes of the present invention, which follow the general principles of the present invention and include common knowledge or conventional technical means in the art not disclosed in the present invention. The present invention is not limited to the exact structure that has been described above and shown in the drawings, and various modifications and changes may be made without departing from the scope of the present invention. The scope of the present invention is only limited by the appended claims.

1. A headphone, comprising:
a sound generating part configured to be worn on a front side of an ear, and the sound generating part comprising a speaker unit;
a main body part configured to be worn on a rear side of the ear;
an ear clip part, opposite ends of the ear clip part being respectively connected to the sound generating part and the main body part, and the ear clip part being configured to switch between a first form and a second form, wherein in the first form, the sound generating part and the main body part jointly clamp the ear, and in the second form, the sound generating part extends into a concha cavity and abuts against a tragus;
a form detecting apparatus provided on at least one of the sound generating part and the main body part, or provided on the ear clip part, and the form detecting apparatus being configured to detect a wearing form of the ear clip part; and
a control apparatus provided on the sound generating part and electrically connected to the form detecting apparatus, and the control apparatus being configured to control an audio output state of the speaker unit according to a detection result of the form detecting apparatus.

2. The headphone of claim 1, wherein the ear clip part comprises an anterior ear section located on the front side of the ear and a posterior ear section located on the rear side of the ear, and the anterior ear section is adapted to deform under an external force to enable the ear clip part to switch between the first form and the second form.

3. The headphone of claim 2, wherein in a case that the ear clip part is in the first form, the anterior ear section is convex in a direction away from the ear, and
wherein in a case that the ear clip part is in the second form, the anterior ear section is concave in a direction close to the ear, to enable the sound generating part to move in a direction close to the tragus and an ear canal.

4. The headphone of claim 1, wherein in a case that the form detecting apparatus is provided on at least one of the sound generating part and the main body part,
the sound generating part comprises a first housing,
the main body part comprises a second housing, and
the form detecting apparatus comprises at least one of:
a magnetic member and a hall sensor, one of the magnetic member and the hall sensor being provided in an inner cavity of the first housing, and another of the magnetic member and the hall sensor being provided in an inner cavity of the second housing, the hall sensor being configured to detect a magnetic induction intensity of the magnetic member, the hall sensor being connected to the control apparatus, and the control apparatus being configured to determine the wearing form of the headphone according to a signal change of the magnetic induction intensity detected by the hall sensor;
infrared sensor provided in the first housing and adapted to emit and receive infrared rays through the light-transmitting window on the first housing, the infrared sensor being electrically connected to the control apparatus, and the control apparatus being configured to determine the wearing form of the headphone according to a signal change of reflected infrared rays received by the infrared sensor, wherein in the first form, an opening direction of the light-transmitting window is away from a human body, and in the second form, the light-transmitting window is at least partially blocked by the human body;
a capacitive sensor separated from the ear in the first form and in contact with the ear in the second form, and the capacitive sensor being electrically connected to the control apparatus, the control apparatus being configured to determine the wearing form of the headphone according to a signal change generated by the capacitive sensor.

5. The headphone of claim 4, wherein in a case that the form detecting apparatus comprises the magnetic member and the hall sensor,
the magnetic member is provided in the inner cavity of the first housing, and the hall sensor is provided in the inner cavity of the second housing, and
the form detecting apparatus further comprises a magnetic conductive cover being arranged on an outer side of the magnetic member.

6. The headphone of claim 4, wherein in a case that the form detecting apparatus comprises the magnetic member and the hall sensor,
the control apparatus is provided in the inner cavity of the first housing, and
the magnetic member and the speaker unit are respectively arranged on opposite sides of the control apparatus in a direction of a human coronal axis.

7. The headphone of claim 4, wherein in a case that the form detecting apparatus comprises the infrared sensor, in the second form, the light-transmitting window is opposite to the tragus.

8. The headphone of claim 4, wherein in a case that the form detecting apparatus comprises the infrared sensor,
the infrared sensor comprises an infrared transmitting unit and an infrared receiving unit, the infrared transmitting unit is configured to emit infrared rays outward from the light-transmitting window and receive infrared rays reflected back by the human body from the light-transmitting window, and
the infrared receiving unit is electrically connected to the control apparatus, and the control apparatus is configured to determine the wearing form of the headphone according to a signal change of the reflected infrared rays received by the infrared receiving unit.

9. The headphone of claim 4, wherein in a case that the form detecting apparatus comprises the infrared sensor, in the second form, the first housing comprises an inner sidewall facing the human body and an outer sidewall away from the human body in a direction of a human coronal axis, the light-transmitting window is provided on the outer sidewall, and the light-transmitting window is located at a front portion of the outer sidewall in a direction of a human sagittal axis.

10. The headphone of claim 4, wherein in a case that the form detecting apparatus comprises the capacitive sensor, in the second form, the capacitive sensor is in contact with the tragus.

11. The headphone of claim 4, wherein in a case that the form detecting apparatus comprises the capacitive sensor, the sound generating part comprises a first housing provided with a mounting window, and the capacitive sensor is fixed in the mounting window, and an outer surface of the capacitive sensor is flush with or protrudes from an outer surface of the first housing.

12. The headphone of claim 1, wherein in a case that the form detecting apparatus is provided on the ear clip part, the ear clip part comprises:
a wrapping piece; and
a deformation assembly disposed in an inner cavity of the wrapping piece and located at an anterior ear section of the ear, and the deformation assembly comprising:
a main deformable body and a deformable driving body, both the main deformable body and the deformable driving body being curved, and the deformable driving body having a different curvature radius from that of the main deformable body, being arranged in a stacked manner with the main deformable body and located on a side of the main deformable body away from the ear, a first end of the main deformable body being fixedly connected to a first end of the deformable driving body, and a second end of the main deformable body being slidably connected to a second end of the deformable driving body, and the deformable driving body being adapted to slide relative to the main deformable body and drive the main deformable body to deform under an external force.

13. The headphone of claim 12, wherein the form detecting apparatus comprises a stress sensor disposed on the anterior ear section, and the stress sensor is configured to sense a stress change of the anterior ear section in a case that the anterior ear section deforms.

14. The headphone of claim 12, wherein the form detecting apparatus comprises an electronic switch comprising a first switch part and a second switch part, and the first switch part is movable relative to the second switch part, and
wherein in the first form, the first switch part is separated from the deformable driving body, and the first switch part and the second switch part are disconnected, and in the second form, the deformable driving body drives the first switch part to move so that the first switch part and the second switch part form a closed circuit.

15. The headphone of claim 14, wherein the first switch part is disposed on a sliding path of the second end of the deformable driving body, and the second end of the deformable driving body is an end of the deformable driving body close to the sound emitting part.

16. A headphone, comprising:
a main body arranged to straddle a helix of an ear in a wearing state, wherein the main body comprises at least a first main body part and a first deformation part that are connected to each other, the first deformation part being adapted to be connected to a sound generating part of the headphone and comprising a first wearing state and a second wearing state, and a distance between the sound generating part and an ear canal orifice in the first wearing state being greater than that in the second wearing state; and
a locking piece having one end being movably connected to the first main body part and another end being selectively connected to the first deformation part so as to enable the first deformation part and the locking piece to switch between a locked state and an unlocked state,
wherein in a case that the first deformation part and the locking piece are in the locked state, the first deformation part is in the first wearing state, and in a case that the first deformation part and the locking piece are in the unlocked state, the first deformation part is in the second wearing state.

17. The headphone of claim 16, further comprising a balancing part connected to an end of the first main body part away from the sound generating part,
wherein in the first wearing state, the balancing part and the sound generating part clamp the ear, and in the second wearing state, the sound generating part extends below a tragus of the ear.

18. The headphone of claim 16, wherein in a case that the locking piece moves in a direction away from the first deformation part, the locking piece is separated from at least a portion of the first deformation part so that the first deformation part and the locking piece are in the unlocked state, and
wherein in a case that the locking piece moves in a direction toward the first deformation part, the locking piece is connected to the first deformation part so that the first deformation part and the locking piece are in the locked state.

19. The headphone of claim 18, wherein one end of the locking piece is slidably disposed on the first main body part, or one end of the locking piece is rotatably connected to the first main body part.

20. The headphone of claim 19, wherein one of the locking piece and the first main body part is provided with a sliding protrusion, and another of the locking piece and the first main body part is provided with a sliding groove, and
wherein the sliding protrusion is slidably disposed in the sliding groove.
